(19) United States
(12) Patent Application Publication
(10) Pub. No.: US 2026/0141625 A1
(43) Pub. Date: May 21, 2026

(54) IMAGE PROCESSING DEVICE, CONTENT SERVER, IMAGE PROCESSING METHOD, AND IMAGE DATA TRANSMISSION METHOD

(71) Applicant: Sony Interactive Entertainment Inc., Tokyo (JP)

(72) Inventors: Akio Ohba, Kanagawa (JP); Norihide Kaneko, Tokyo (JP); Takayuki Shinohara, Tokyo (JP)

(21) Appl. No.: 19/446,748

(22) Filed: Jan. 12, 2026

Related U.S. Application Data
(63) Continuation of application No. PCT/JP2023/025960, filed on Jul. 13, 2023.

(51) Int. Cl. G06T 15/20; G06T 7/11; G06T 15/06

(52) U.S. Cl. CPC G06T 15/205; G06T 7/11; G06T 15/06

(57) ABSTRACT

A content server 20 transmits, on a tile-by-tile basis, data corresponding to viewpoint information from among a reference map 300a, which indicates distribution of color values or the like of a display target, to the image processing device 10 (s1, s2). An image processing device 10 generates a display image using the reference map. The content server 20 updates the changed area of the reference map on a tile-by-tile basis in response to changes or the like in the image world, and transmits data of the tile corresponding to the viewpoint information to the image processing device 10 (s3). When a change occurs on the image processing device 10 side, the information is transmitted to the content server 20 (s4), and the reference map is also updated in the image processing device 10

### CROSS-REFERENCE TO RELATED APPLICATIONS

This application is a continuation application of and claims the benefit of priority to PCT Application No. PCT/JP2023/025960, filed on Jul. 13, 2023, the contents of which are hereby incorporated by reference.

### TECHNICAL FIELD

The present invention relates to an image processing device, content server, and image processing method for performing image display processing.

### BACKGROUND TECHNOLOGY

Recent advances in information processing and image display technology have made it possible to experience the world of images in a variety of forms. For example, displaying panoramic images on a head-mounted display and displaying images corresponding to the user's line of sight can enhance the sense of immersion in the world of images and improve the operability of applications such as games. Furthermore, by displaying image data streamed from a server with abundant resources, users can enjoy high-definition images and realistic games regardless of location or size.

### SUMMARY OF INVENTION

### Problem to be Solved by Invention

Regardless of the purpose or format of image display, how to efficiently draw and display an image is always an important issue. For example, in situations where a three-dimensional object can be viewed from various angles by allowing for freedom of viewpoint and line of sight, high responsiveness is required for changes in the display in response to viewpoint movement. The same is true when a three-dimensional object moves or deforms. However, displaying high-quality images requires higher resolution and complex calculations, which increases the image processing load. As a result, delays tend to occur in the changes in the image world that should be expressed.

The present invention is made in consideration of these issues, and an object thereof is to provide technology for displaying images with low latency and high quality, regardless of the display content or environment.

### Means to Solve the Problem

In order to solve the above problems, one aspect of the present invention relates to an image processing device. This image processing device includes one or more processors having hardware, and the one or more processors acquire hierarchical map data in which multiple reference maps representing distribution of color values of an object to be displayed and distribution of predetermined parameters indicating surface characteristics of the object are layered at different resolutions, generate and output a display image using data of a layer and an area corresponding to viewpoint information for the object from among the hierarchical map data, and when a change occurs or a change is predicted in the object, selectively acquire and update data of a type, layer, and area of the reference map that represents the change from among the hierarchical map data.

Another aspect of the present invention relates to a content server. The content server includes one or more processors having hardware, and the one or more processors generate hierarchical map data in which multiple reference maps representing distribution of color values of an object to be displayed and distribution of predetermined parameters indicating surface characteristics of the object are layered at different resolutions, and transmit data of a layer and area of the hierarchical map data determined based on viewpoint information for the object to an image processing device that generates and displays a display image using the hierarchical map data.

Still another aspect of the present invention relates to an image processing method. The image processing method includes: acquiring hierarchical map data in which multiple reference maps representing distribution of color values of an object to be displayed and distribution of predetermined parameters indicating surface characteristics of the object are layered at different resolutions; generating and outputting a display image using data of a layer and an area corresponding to viewpoint information for the object from among the hierarchical map data; and when a change occurs or a change is predicted in the object, selectively acquiring and updating data of a type, layer, and area of the reference map that represents the change from among the hierarchical map data.

Still another aspect of the present invention relates to an image data transmission method. The image data transmission method includes: generating hierarchical map data in which multiple reference maps representing distribution of color values of an object to be displayed and distribution of predetermined parameters indicating surface characteristics of the object are layered at different resolutions; and transmitting data of a layer and area of the hierarchical map data determined based on viewpoint information for the object to an image processing device that generates and displays a display image using the hierarchical map data.

Note that any combination of the above components, and any conversion of the expression of the present invention between methods, devices, systems, computer programs, data structures, recording media, and the like, are also valid aspects of the present invention.

### Effect of the Invention

According to the present invention, images can be displayed with low latency and high quality regardless of the display content or environment.

### BRIEF DESCRIPTION OF THE DRAWINGS

FIG. 1 is a diagram illustrating a configuration example of an image display system according to the present embodiment.

FIG. 2 is a diagram illustrating an example of an image that can be displayed according to the present embodiment.

FIG. 3 is a diagram illustrating another example of the image that can be displayed according to the present embodiment.

FIG. 4 is a diagram illustrating a relationship between reference map data configured at multiple resolutions and a display image according to the present embodiment.

FIG. 5 is a diagram illustrating an example of a data structure of the reference map used in the present embodiment.

FIG. 6 is a diagram illustrating an overview of a display image generation process that can be used in the present embodiment.

FIG. 7 is a flowchart illustrating a pixel value determination processing procedure when ray marching is employed in the present embodiment.

FIG. 8 is a diagram illustrating an overview of a height map according to the present embodiment.

FIG. 9 is a diagram illustrating an internal circuit configuration of an image processing device according to the present embodiment.

FIG. 10 is a diagram illustrating a functional block configuration of a content server and an image processing device in the present embodiment.

FIG. 11 is a diagram illustrating in more detail functional block configurations of a reference map generation unit in the content server and a reference map generation unit in the image processing device in the present embodiment.

FIG. 12 is a flowchart illustrating a processing procedure in which the content server generates and updates the reference map while transmitting necessary data to the image processing device in the present embodiment.

FIG. 13 is a flowchart illustrating the processing procedure in which the image processing device generates and outputs the display image based on the reference map in the present embodiment.

FIG. 14 is a diagram schematically illustrating the transition of the reference map when the reference map generation unit is provided in both the content server and the image processing device in the present embodiment.

FIG. 15 is a diagram for explaining an aspect in which the display image is generated using multiple reference maps in the present embodiment.

FIG. 16 is a diagram exemplifying a reference map prepared in an aspect in which multiple model data are used in combination in the present embodiment.

FIG. 17 is a diagram for explaining switching of the reference maps in response to changes in viewpoint in the aspect in which the multiple model data are used in combination in the present embodiment.

FIG. 18 is a diagram illustrating switching of the reference maps in response to changes in viewpoint in the aspect in which the multiple model data are used in combination in the present embodiment.

FIG. 19 is a diagram illustrating a method for defining switching between a base model and a part model in the present embodiment.

FIG. 20 is a diagram illustrating a relationship between a general view screen and a screen corresponding to a distorted image.

FIG. 21 is a diagram illustrating a method in which the reference map generation unit determines a pixel value for the reference map in the present embodiment.

FIG. 22 is a diagram illustrating the configuration of the reference map when implementing foveated rendering in the present embodiment.

FIG. 23 is a diagram illustrating an aspect in which the distribution of shrink factors used in ray marching is represented as the reference map in the present embodiment.

FIG. 24 is a diagram illustrating the effect on a display image of introducing the shrink factor in the present embodiment.

### DESCRIPTION OF THE EMBODIMENTS

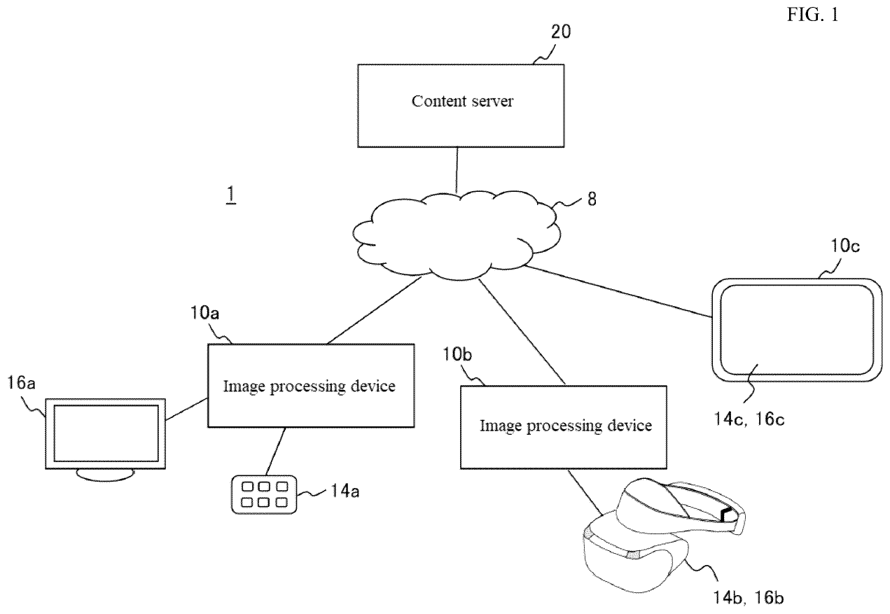

FIG. 1 illustrates a configuration example of an image display system to which the present embodiment can be applied. The image display system 1 includes image processing devices 10a, 10b, and 10c that display images in response to a user operation, and a content server 20 that provides image data used for the display. The image processing devices 10a, 10b, and 10c are connected to input devices 14a, 14b, and 14c for the user operation, respectively, and display devices 16a, 16b, and 16c for displaying images. The image processing devices 10a, 10b, and 10c and content server 20 can establish communication via a network 8, such as a wide area network (WAN) or a local area network (LAN).

The image processing devices 10a, 10b, and 10c may be connected to the display devices 16a, 16b, and 16c and the input devices 14a, 14b, and 14c via either a wired or wireless connection. Alternatively, two or more of these devices may be integrated. For example, in the drawing, the image processing device 10b is connected to a head-mounted display which is the display device 16b. The head-mounted display can change the field of view of the display image depending on the movement of the user wearing the head-mounted display, and therefore also functions as the input device 14b.

The image processing device 10c is a portable terminal, and is integrally configured with the display device 16c and the input device 14c, which is a touchpad that covers the screen of the display device 16c. As such, the external shape and connection configuration of the illustrated devices are not limited. The number of image processing devices 10a, 10b, and 10c and content servers 20 connected to the network 8 is also not limited. The content server 20 may also be a cloud server including multiple information processing devices. Hereinafter, the image processing devices 10a, 10b, and 10c are collectively referred to as an image processing device 10, the input devices 14a, 14b, and 14c as an input device 14, and the display devices 16a, 16b, and 16c as a display device 16.

The input device 14 may be any one or a combination of general input devices, such as a controller, keyboard, mouse, touchpad, or joystick, and supplies the content of the user operation to the image processing device 10. The display device 16 may be a general display such as a liquid crystal display, a plasma display, an organic EL display, a wearable display, or a projector, and displays the image output from the image processing device 10.

The content server 20 processes electronic content and provides the image processing device 10 with the data necessary to display images representing the results. The type of electronic content processed by the content server 20 is not particularly limited, and may include electronic games, simulators, virtual spaces, and decorative images. However, the subject of electronic content processing is not limited to the content server 20, and the electronic content may be processed in the image processing device 10 to generate the display image.

In the present embodiment, the type and purpose of the image displayed by the image processing device 10 on the display device 16 are not limited, and the image may include moving or still images, captured images of the real world, virtual world images rendered using computer graphics, or images that combine these. The image world of the display target may be defined as either two-dimensional or three-dimensional. Furthermore, the user may move an object present in the image world or change their viewpoint or line of sight relative to the image world via the input device 14. When the display device 16 is the head-mounted display, the viewpoint or line of sight may be changed in response to the user's head movement. This allows the user to feel immersed in the image world.

In the present embodiment, the basic principle is to acquire a wide range of distributions of predetermined parameters that indicate surface characteristics, such as color values that constitute the image world of the display target, as well as unevenness and material, and generate the display image by referring to these. Hereinafter, the data on the distribution of various parameters referenced when generating the display image is referred to as a “reference map”. By generating a reference map over a wide area and with high resolution, the processing load at the stage of generating the display image can be reduced, and high-quality images can be displayed with low latency in response to changes in viewpoint or line of sight.

Furthermore, when expressing changes in the display content, such as the movement, deformation, or color change of the display target, by updating only the corresponding area of the wide-range reference map as needed, these can be reflected in the display image with low latency. In this case, by utilizing the abundant processing resources of the content server 20 to update the reference map at high speed and sending only the data of the required area to the image processing device 10, stable display using the reference map can be performed regardless of the communication bandwidth. Furthermore, by making it possible for the image processing device 10 to update the reference map, low latency can be further improved.

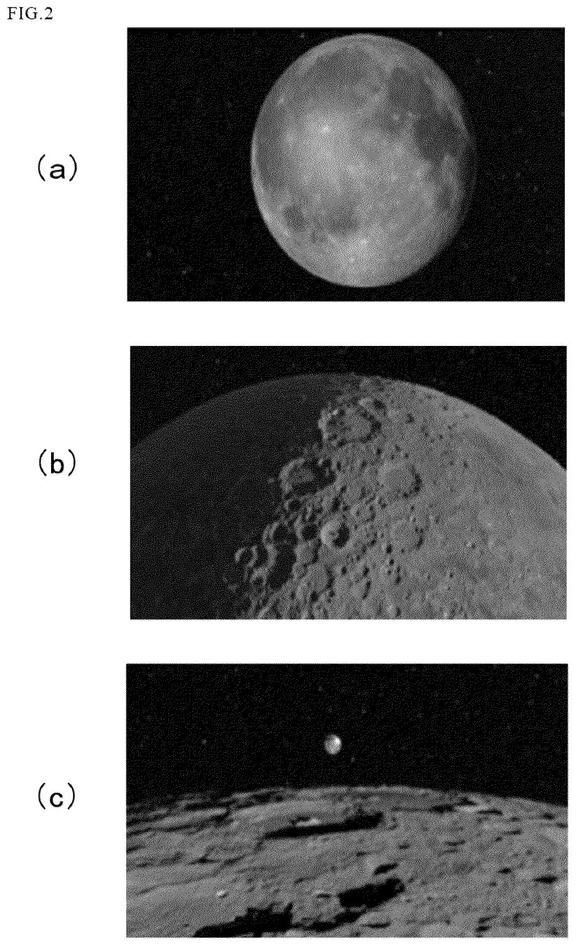

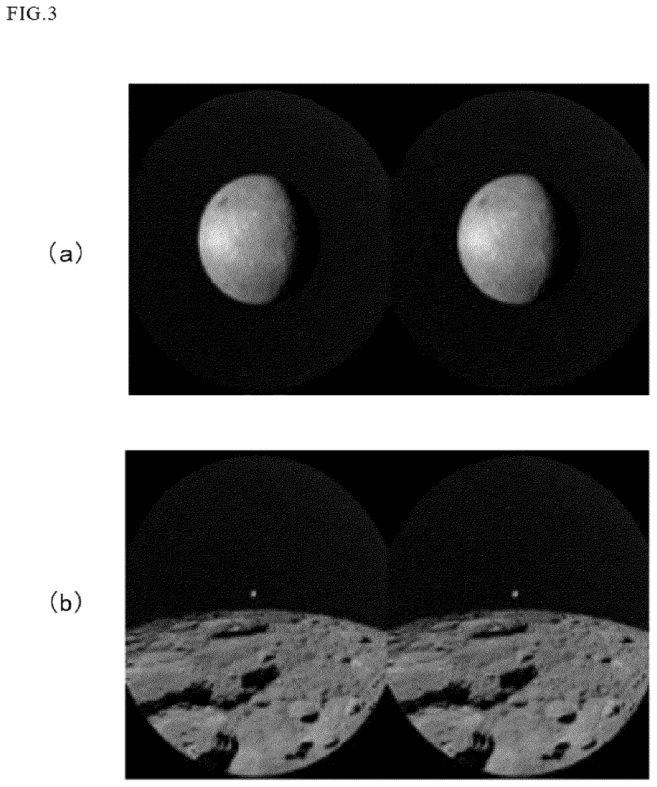

FIG. 2 illustrates an example of an image that can be displayed in the present embodiment. In this example, the display target is the moon. By moving the viewpoint closer to the moon as illustrated in (a), (b), and (c), craters become visible on the surface of the moon, which previously appeared spherical, and it becomes clear that these are actually large hills. FIG. 3 illustrates another example of the image that can be displayed in the present embodiment. In this example, the display target is also the moon, but the display device 16 is the head-mounted display.

In this case, a left-eye image and a right-eye image with appropriate parallax are displayed side by side on the left and right sides of the display screen, allowing the image world to be viewed in three dimensions. Furthermore, a general head-mounted display has an eyepiece lens between the display panel and the eyes to allow the display image to be viewed over a wide field of view. Therefore, to ensure that an undistorted image is viewed through the eyepiece lens, the display image is distorted in advance to counteract the distortion and chromatic aberration of the eyepiece lens.

Due to these characteristics, the display images illustrated in (a) and (b) are each composed of distorted parallax images. Furthermore, by moving the viewpoint closer to the moon as in (a) and (b), the appearance of the moon changes, as in FIG. 2, and the user can also experience changes in distance. In any case, as shown in FIGS. 2 and 3, even for a large display target such as the moon, by allowing a significantly wide range of changes in display magnification to accommodate it, it is possible to achieve a dynamic image representation with a sense of realism. For this reason, in the present embodiment, reference map data is preferably prepared at multiple resolutions.

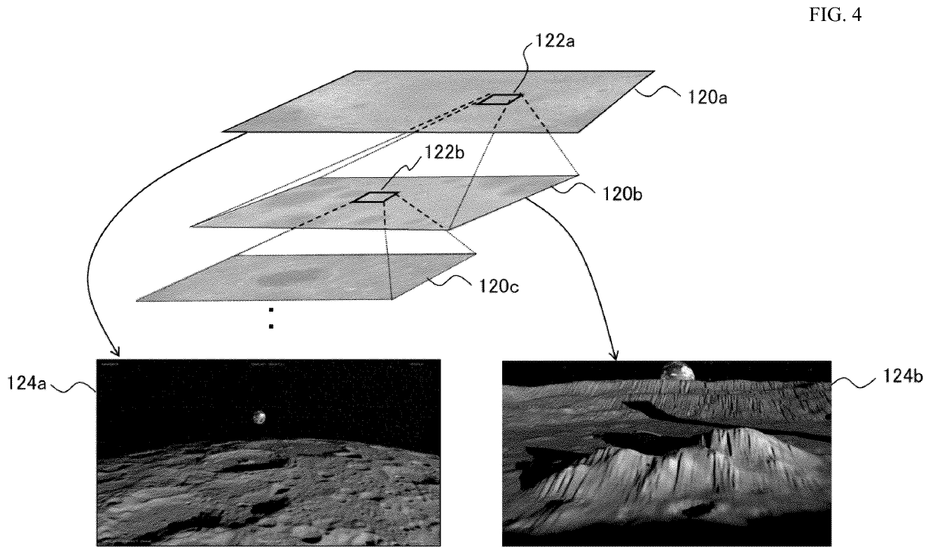

FIG. 4 is a diagram illustrating a relationship between reference map data configured at multiple resolutions and the display image. Here, height maps 120a, 120b, and 120c are illustrated as an example of a reference map, representing the lunar surface's unevenness, that is, the distribution of height, relative to the lunar surface. For example, the height map 120a represents the distribution of height across the entire lunar surface. The height map 120b represents the height of the lunar surface in a partial area 122a of the height map 120a at a higher resolution than height map 120a. The height map 120c represents the height of the lunar surface in a partial area 122b of the height map 120b at a higher resolution than the height map 120b.

For example, the image processing device 10 renders an image 124a of the moon seen from a certain viewpoint using the height map 120a with the lowest resolution and a color map, material map, or the like with the same resolution. Furthermore, an image 124b of the moon seen from a closer viewpoint is rendered using the height map 120b with a higher resolution and the color map, material map, or the like with the same resolution. In this way, by switching the resolution of the reference map depending on the distance between the display target and the viewpoint, it is possible to render an image with an appropriate level of detail with a similar amount of processing, regardless of the display magnification.

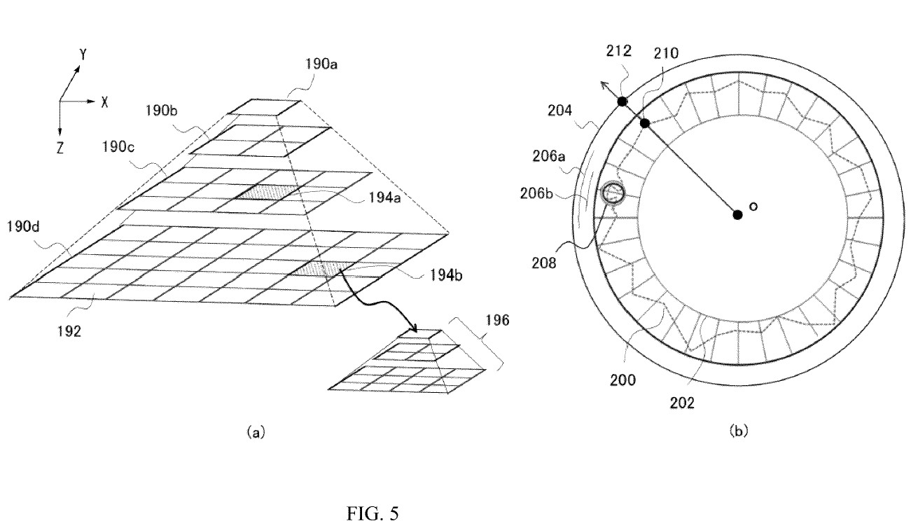

Note that while the drawings illustrate the height maps with the limited area for each increasing resolution, this is not intended to limit the scope of the present embodiment. For example, when every part of an object needs to be enlarged for viewing, the reference map is prepared for the entire surface, regardless of the resolution. Meanwhile, when the area to be enlarged is limited to a specific area of the object, the amount of data can be reduced by preparing a high-resolution reference map for only the partial area, as illustrated in the drawings. FIG. 5 is a diagram illustrating an example of the data structure of the reference map used in the present embodiment. As illustrated in (a), the reference map data has a hierarchical structure in which the distribution of various parameters represented on the horizontal plane (XY plane) is arranged in multiple layers in the depth (Z axis) direction. In the drawings, four layers such as a first layer 190a, second layer 190b, third layer 190c, and fourth layer 190d are illustrated, but the number of layers is not limited to this. Hereinafter, data having the hierarchical structure will be referred to as “hierarchical data”.

The hierarchical data illustrated in FIG. 5 has a quadtree hierarchical structure, with each layer consisting of one or more tile areas 192. The tile area 192 (hereafter sometimes simply referred to as a “tile”) is an area formed by dividing the reference map of each layer into equal-sized areas, such as 256×256 pixels. Here, a “pixel” refers to the unit of area to which a value is assigned on the map. The hierarchical data represents the distribution of target parameter values, such as color values, at different resolution (levels of detail), with the first layer 190a having the lowest resolution and the fourth layer 190d having the highest resolution in the illustrated example.

(b) illustrates a cross-sectional view of the positional relationship between the object to be displayed and the surface of the reference map. In this example, an object 200 has a sphere 202 as the basic shape and an irregular surface. For example, a spherical surface 204 that encompasses the object 200 and shares a common center o is set as the surface representing the reference map. By mapping the value (for example, value at point 210) of various parameters on the surface of the object 200 to a position (for example, the position of point 212) on the spherical surface 204 in the same orientation from the center o, a full sphere reference map is obtained.

By expanding this full sphere reference map into two dimensions using well-known methods, the reference maps for each layer illustrated in (a) are obtained. In the present embodiment, the resolution of each layer is not limited to being obtained by enlarging or reducing one reference map, but the reference map can be generated independently for each layer and for each tile according to each level of detail. In the drawing, when updating data for a partial area 206a of the spherical surface 204 at a specific level of detail, for example, only the tile 194a in the third layer 190c may be partially updated. When updating the data of the partial area 206b at a higher level of detail, only the tile 194b of the fourth layer 190d may be partially updated.

When generating the display image, qualitatively, the viewpoint's position information relative to object 200 is converted into position coordinates in a virtual three-dimensional space (XYZ space) that defines the hierarchical data, and the reference layer is determined based on the Z coordinate. For example, a switching boundary can be set in the Z coordinate between layers, and the reference layer is switched when the viewpoint crosses the boundary. This allows for an image to be displayed in which the surface appearance is rendered in greater detail the closer the viewpoint is to the partial areas 206a and 206b of the object 200. However, as described below, in practice, the reference layer and area are quickly acquired using a lookup table or similar.

In the example illustrated, the hierarchical data 196 of the reference map is prepared separately for a portion 208 of the object 200. This allows for more detailed representation of specific locations and greater freedom in partial addition and deletion of the object, while minimizing the increase in the data size of the entire reference map. Furthermore, a data structure that treats portions as individual objects makes it possible to represent the shape that cannot be represented by the height map, which represents the height from a base shape in the original reference map.

In this example, the additional hierarchical data 196 is associated with the tile 194b in the fourth layer 190d of the main hierarchical data. As a result, when the viewpoint approaches the partial area 206b of the object 200, the reference map used for display is switched to the additional hierarchical data 196. This configuration will be described in more detail later.

Note that the reference map is not limited to the full sphere data, and the reference map may also be general central projection data, or may include both. Furthermore, the method for representing full sphere data is not particularly limited, and methods such as equirectangular projection and methods using a Yin-Yang lattice may be used. Furthermore, the parameters represented as a reference map are not limited to color values, height, and material. For example, when using procedural modeling to build a three-dimensional object model using a calculation formula, the formula used and the distribution of various parameters introduced into the formula may be represented as a reference map. Alternatively, the distribution of feature vectors representing the image world, obtained through deep learning, may be represented as a reference map.

The image processing device 10 and the content server 20 store the reference map, compressed and encoded for each tile, in their respective storage devices. The image processing device 10 reads, from the storage device, the data for the corresponding tile in the layer of the reference map that corresponds to the viewpoint or line of sight at each time. Alternatively, the image processing device 10 may transmit information related to the viewpoint, or the corresponding required level of detail or field of view, to the content server 20 and request the corresponding tile data. The image processing device 10 then decodes and expands the acquired tile data, stores the tile data in memory, and references the tile to generate the display image.

In the present embodiment, the hierarchical data that constitutes the reference map is basically updated and transmitted on a tile-by-tile basis. This allows the computing resources, communication bandwidth, and memory capacity required for data generation and transmission processing to be roughly constant regardless of changes in the viewpoint or line of sight. Furthermore, by responding to changes in the image world with minimal necessary change processing, efficiency is improved and the changes can be reflected in the display with low latency.

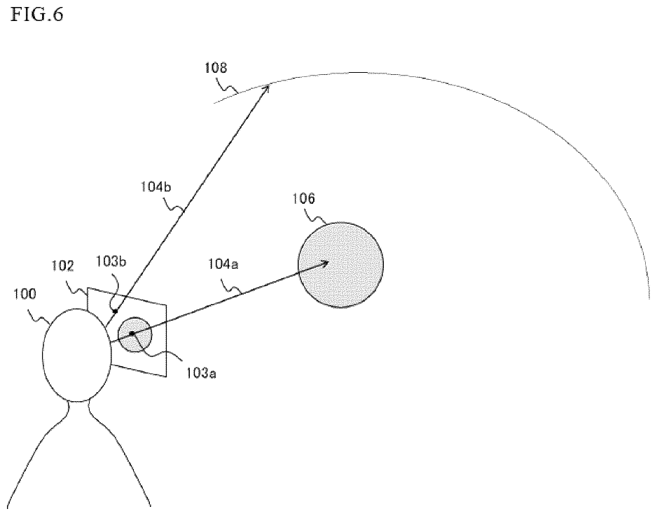

Next, the process of generating the display image using the reference map will be described. Note that the technology disclosed in International Publication No. 2022/113246 can be applied to this process. FIG. 6 is a diagram illustrating an overview of the display image generation process that can be used in the present embodiment. As a simple example, a spherical object 106, such as the moon, is used as the display target. First, the object 106 defined by a three-dimensional model and a view screen 102 corresponding to the viewpoint and line of sight of a user 100 are disposed in a world coordinate system that defines the virtual space. Essentially, the display image is generated by projecting the object 106 and background 108 onto the view screen 102.

By acquiring the viewpoint position and line of sight direction at a predetermined rate in response to the user operation and game progress, and then changing the position and orientation of the view screen 102 accordingly, it is possible to display video images of the object 106 from various distances and angles. This method, in particular, achieves high-quality image representation by using ray tracing as the base. The ray tracing is generally a technique that generates rays that pass through each pixel on the view screen 102 from the viewpoint, and acquires color information of the destination as pixel values by tracing the path while taking into account interactions such as reflection, transmission, and refraction.

In the example illustrated, since a ray 104a passing through a pixel 103a reaches the object 106, and the pixel value of the pixel 103a is determined by obtaining the color of the destination. Similarly, since a ray 104b passing through a pixel 103b does not include the object 106 in the path, the color of the destination in background 108 is obtained as the pixel value of the pixel 103b. However, in reality, the ray 104a may take a complex path, such as being reflected by or passing through the object 106, reaching another object, and then being further reflected or passed through.

Therefore, by solving a rendering equation taking into account the shape and reflection properties of each object, the position of the light source, and other factors, realistic image representations that reflect the material and surrounding environment can be achieved. The ray marching is one method for efficiently tracking the ray until the ray reaches the object. The ray marching is a method that uses a distance function defined for each object's shape to acquire the distance from the ray to the object, and then advances the ray the distance to the nearest object to determine the final destination of the ray.

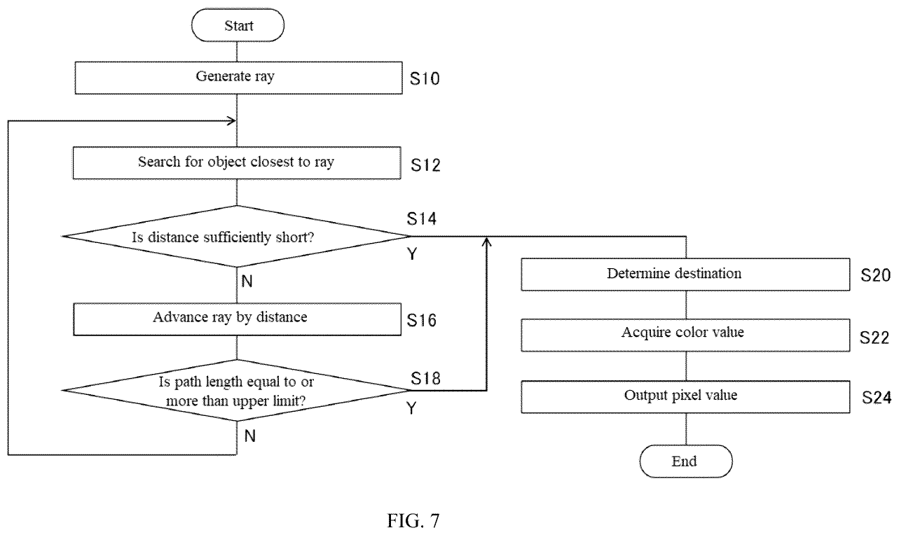

FIG. 7 is a flowchart illustrating a pixel value determination procedure when the ray marching is employed in the present embodiment. This flowchart illustrates the procedure for determining the value of one pixel in a display image, and to render the entire display image, the illustrated procedure is repeated for all pixels.

First, as described above, the view screen corresponding to the viewpoint and line of sight is set in the virtual space in which the object to be displayed is disposed, and the ray is generated from the viewpoint through the target pixel (S10). This process actually corresponds to defining the direction in which the ray will advance. Next, the object closest to the ray position (first, the viewpoint) is searched in all directions (S12).

When the distance to the nearest object is not short enough to be considered as if the ray has come into contact with the object (N in S14), the ray is advanced by the distance (S16). When the path length of the ray so far has not reached a preset upper limit (N at S18), the system searches for the nearest object at the destination (S12). Thereafter, the same process is repeated, and when the object is detected that is close enough to be considered as being in contact with the ray (Y in S14), the object is determined as the destination (S20).

Then, the color value of the ray's destination on the object is acquired (S22). The acquired color value is written to a frame buffer or the like as the pixel value of the target pixel, and output to the display device 16 as one pixel of the display image (S24). Meanwhile, when the path length of the ray has reached the upper limit in S18 (Y at S18), it is determined that the object is not included in the path, and a position on the background in the direction is determined as the destination, and the pixel value is then determined (S20-S24).

In the present embodiment, in S22, the color value is acquired through simple processing by sampling the values of various parameters, such as the color value, from the reference map. Generating the reference map over time or by using abundant resources such as the content server 20 can simplify the calculations required to generate the display image, while still generating a high-quality image based on a physical model similar to that of traditional ray tracing. Even when the reference map is allowed to be updated during display, it can be regenerated only for the tiles to be updated, as described above, so that the display image can be updated with low latency.

Note that the means for generating the reference map is not particularly limited, may use captured images or measurement values from various sensors, or values may be estimated using deep learning. When using the deep learning, learning can be performed for each level of the layer of the reference map, that is, for each level of detail in the image, making it possible to make estimations that are hierarchically limited. Furthermore, the reference map used to acquire the color value in S22 does not have to be the color value itself, it can be any parameter that affects the color. For example, the height map and material reference map may be used to perform lighting processing, such as expressing the reflection of the light source, based on the relationship between the normal and ray of the object's surface, and the reflection coefficient.

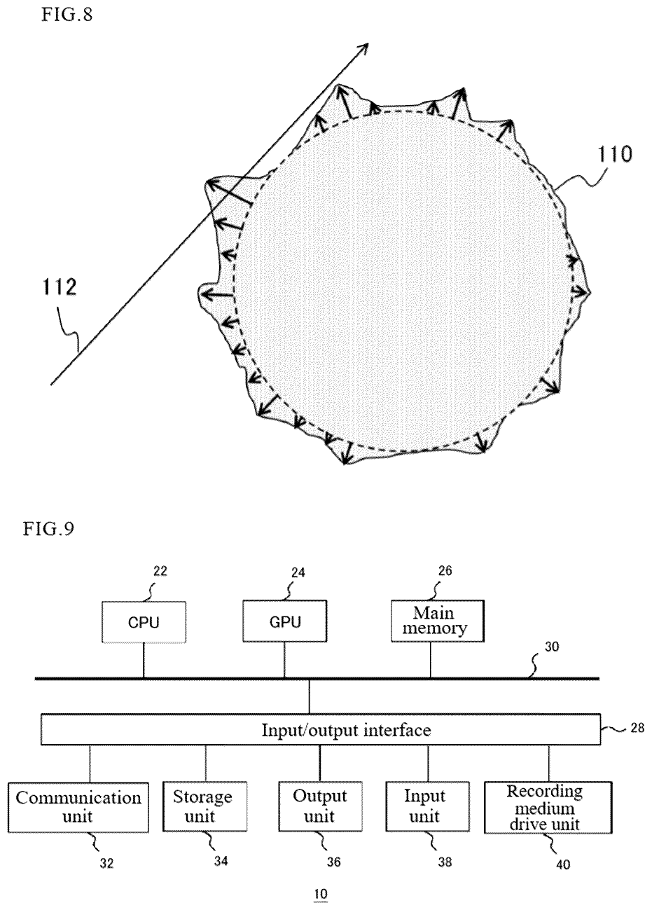

Furthermore, in S12, by referencing the height map when acquiring the distance between the ray and the object, the unevenness of the object's surface can be accurately represented. FIG. 8 is a diagram for explaining an overview of the height map. In this example, a cross-section of the object 110, which has an approximately spherical shape and an uneven surface, is illustrated. The height map, as indicated by the thick arrow in the drawing, represents the distribution of height in the normal direction from the surface of the sphere, which is the basic shape. When only the basic shape is considered, the ray 112 illustrated in the drawing does not reach the object, but by adding height to the sphere's surface using the height map, the ray 112 correctly reaches the object 110.

This allows the unevenness of the surface of the object 110 to be accurately represented. In the ray marching, the distance between the ray and the object 110 can be derived using the height map. The height map can be acquired simultaneously during the process of generating the reference map of color values, for example, by path tracing using a polygon mesh. Alternatively, as described above, the height map may be acquired by the information the measurement values by a sensor, the captured images by a stereo camera, or estimations by the deep learning.

FIG. 9 illustrates the internal circuit configuration of the image processing device 10. The image processing device 10 includes a Central Processing Unit (CPU) 22, a Graphics Processing Unit (GPU) 24, and a main memory 26. These components are interconnected via a bus 30. An input/output interface 28 is also connected to the bus 30. The input/output interface 28 is connected to a communication unit 32 consisting of a peripheral device interface such as a USB or a wired or wireless LAN network interface, a storage unit 34 such as a hard disk drive or non-volatile memory, an output unit 36 that outputs data to the display device 16, an input unit 38 that inputs data from the input device 14, and a recording medium drive unit 40 that drives a removable recording medium such as a magnetic disk, optical disk, or semiconductor memory.

The CPU 22 controls the entire image processing device 10 by executing an operating system stored in the storage unit 34. The CPU 22 also executes various programs read from removable recording media and loaded into the main memory 26, or downloaded via the communication unit 32. The GPU 24 has a geometry engine function and a rendering processor function, performs rendering processing in accordance with a render command from the CPU 22, and stores the display image in a frame buffer (not illustrated). The display image stored in the frame buffer is then converted into a video signal and output to the output unit 36. The main memory 26 is composed of a Random Access Memory (RAM) and stores programs and data necessary for processing. The content server 20 has a similar internal circuit configuration.

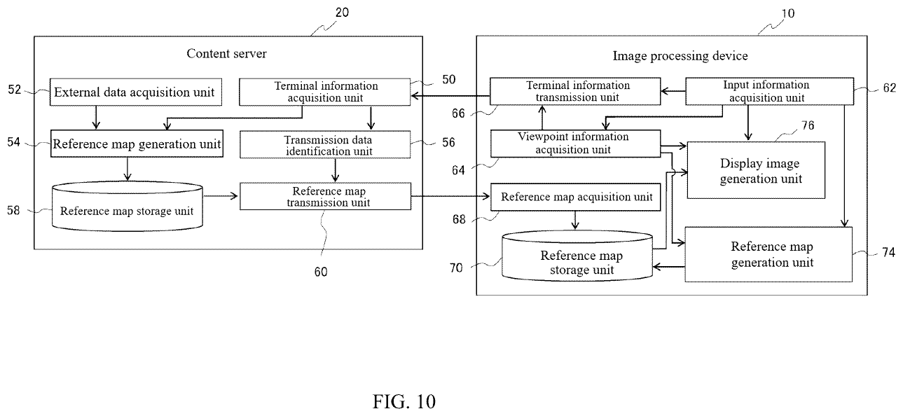

FIG. 10 illustrates the functional block configuration of the content server 20 and image processing device 10 in the present embodiment. In this drawing, the various elements depicted as functional blocks performing various processes can be configured in hardware using the CPU 22, GPU 24, main memory 26, and other LSIs illustrated in FIG. 9, and in software, the elements are implemented by programs loaded into the main memory 26 to implement communication functions, image processing functions, various arithmetic functions, and the like. Therefore, those skilled in the art will understand that these functional blocks can be implemented in various forms, using only hardware, only software, or a combination of these, and are not limited to any one of these.

The content server 20 includes a terminal information acquisition unit 50 that acquires information necessary for transmitting and updating reference map data from the image processing device 10, an external data acquisition unit 52 that acquires external data used to generate the reference map, a reference map generation unit 54 that generates and updates the reference map, a reference map storage unit 58 that stores the reference map, a transmission data identification unit 56 that identifies data to be transmitted to the image processing device 10, and a reference map transmission unit 60 that transmits the reference map data to the image processing device 10.

The terminal information acquisition unit 50 acquires information (hereinafter, sometimes simply referred to as “viewpoint information”) about the virtual viewpoint or line of sight with respect to the display target, or information about the layer and area of the reference map necessary for generating the display image, from the image processing device 10. Here, the layer of the reference map can be rephrased as the resolution or level of detail (LoD) of the reference map. The terminal information acquisition unit 50 may also acquire data that affects the reference map, acquired by the image processing device 10, from the image processing device 10. Examples of such data include the content of user operation, or output data from an imaging device or various sensors connected to the image processing device 10.

The external data acquisition unit 52 acquires external data that affects the reference map. For example, when the captured image is to be displayed, the external data acquisition unit 52 acquires data on images captured by the imaging device (not illustrated) or images captured at a remote location and uploaded. In this case, the external data acquisition unit 52 may acquire information on the three-dimensional structure corresponding to the captured image from a sensor that acquires the three-dimensional structure of the subject.

The three-dimensional structure can be acquired, for example, by a general distance measurement sensor such as a ToF (Time of Flight) sensor. Alternatively, the external data acquisition unit 52 may analyze the captured image to acquire information related to the three-dimensional structure and material of the subject, or may acquire such information inferred from the captured image using a deep learning system (not illustrated).

The reference map generation unit 54 generates and updates the reference map based on data acquired by the terminal information acquisition unit 50 from the image processing device 10 and data acquired by the external data acquisition unit 52. The reference map generation unit 54 may render all or part of the reference map itself based on specifications of a computer program or the like. Furthermore, as described below, the reference map generation unit 54 may generate the reference map with distortion that takes into account the eyepiece lens based on viewpoint information acquired by the terminal information acquisition unit 50.

In any case, the reference map generation unit 54 preferably generates the reference map with a range wider than the field of view of the display image, in the hierarchical structure such as that illustrated in FIG. 5. The reference map generation unit 54 may generate a reference map common to the image processing devices 10 of users simultaneously sharing the space of the display target, such as players participating in the same game, or may generate a reference map for each image processing device 10. Alternatively, the reference map generation unit 54 may generate a reference map common to all image processing devices 10 regardless of the display period.

The reference map generation unit 54 compresses and encodes the generated reference map for each tile and stores the reference map in the reference map storage unit 58. Moreover, the reference map generation unit 54 also updates, on a tile-by-tile basis, areas of the reference map stored in the reference map storage unit 58 that require updating, as needed. The transmission data identification unit 56 determines, for each destination image processing device 10, the tile to be transmitted from the reference map, based on the viewpoint information acquired by the terminal information acquisition unit 50.

When the image processing device 10 issues a data request specifying the required layer or area, the transmission data identification unit 56 may determine the tile to be transmitted based on the specified information. The reference map transmission unit 60 reads the tile data determined by the transmission data identification unit 56 from the reference map storage unit 58 and transmits the tile data to the image processing device 10 as needed.

The image processing device 10 includes an input information acquisition unit 62 that acquires input information such as user operation, a viewpoint information acquisition unit 64 that acquires viewpoint information for the display target, a terminal information transmission unit 66 that transmits information necessary for acquiring and updating the reference map to the content server 20, a reference map acquisition unit 68 that acquires the reference map from the content server, a reference map storage unit 70 that stores the reference map, a reference map generation unit 74 that generates and updates the reference map, and a display image generation unit 76 that generates a display image using the reference map.

The input information acquisition unit 62 acquires the content of the user operation via the input device 14 as needed. When the display device 16 is a head-mounted display, the input information acquisition unit 62 may acquire position and orientation information of the head-mounted display at a predetermined rate based on the measurement value from a motion sensor built into the head-mounted display.

The input information acquisition unit 62 may also acquire other data that affects the reference map. For example, the input information acquisition unit 62 acquires the captured image and data on the three-dimensional structure of the subject as needed from the input device 14, such as an imaging device or a distance sensor. This function may basically be the same as that of the external data acquisition unit 52 of the content server 20. The input information acquisition unit 62 may also acquire material information of the subject from the user via the input device 14.

The viewpoint information acquisition unit 64 acquires the viewpoint and line-of-sight information with respect to the display target at a predetermined rate. For example, the viewpoint information acquisition unit 64 acquires the viewpoint and line-of-sight operations of the user, or information on the position and orientation of the head-mounted display, from the input information acquisition unit 62, and derives viewpoint information based on this information. The viewpoint information is used when generating the display image as illustrated in FIG. 6, and is also used to determine the layer and area of the reference map required for the display.

The terminal information transmission unit 66 transmits the viewpoint information or information on the layer and area of the reference map required for display to the content server 20. The terminal information transmission unit 66 may also transmit to the content server 20 the content of the user operation that affect the reference map, captured image, output data from various sensors, and the like. The reference map acquisition unit 68 acquires the reference map data on a tile-by-tile basis from the content server 20 and stores the reference map data in the reference map storage unit 70.

The reference map generation unit 74 generates and updates the reference map based on at least one of the content of the user operation, captured images, various sensor data, viewpoint information, and the like. The reference map generation unit 74 may also render the reference map based on specifications from a computer program or the like. This function may basically be the same as that of the reference map generation unit 54 of the content server 20. By providing the reference map generation unit 74 inside the image processing device 10, the reference map can be updated without waiting for data from the content server 20, and as a result, the display image can be changed with low latency.

The reference map generation unit 74 appropriately compresses and encodes the generated reference map and stores the reference map in the reference map storage unit 58. The reference map generation unit 74 also updates, on a tile-by-tile basis, the area of the reference map stored in the reference map storage unit 58 that require updating. The display image generation unit 76 expands at least a portion of the data corresponding to the viewpoint information from the latest reference map stored in the reference map storage unit 70 into memory, and generates the display image using the data for the layer and area corresponding to the viewpoint information.

As described above, the display image generation unit 76 generates the display image by modified ray tracing using the reference map. However, the method used to generate the display image is not limited to the ray tracing, and multiple methods, such as the ray tracing and procedural modeling, may be combined. The display image generation unit 76 sequentially outputs the generated image data to the display device 16 for display.

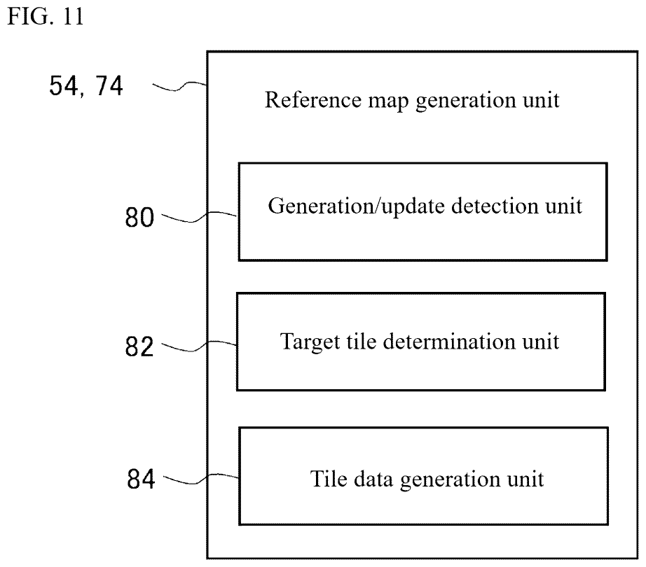

FIG. 11 illustrates in more detail the functional block configuration of the reference map generation unit 54 in the content server 20 and the reference map generation unit 74 in the image processing device 10. The reference map generation units 54 and 74 each include a generation/update detection unit 80, a target tile determination unit 82, and a tile data generation unit 84. The generation/update detection unit 80 detects the need to generate or update the reference map. For example, in the content server 20, the generation/update detection unit 80 detects the need to update the reference map based on changes in the captured image and sensor output data acquired by the external data acquisition unit 52.

As an example, when displaying the image of a landscape captured from a fixed point, changes occur in the captured images depending on the season, weather, time, subject movement, and other factors. The generation/update detection unit 80 compares the captured image with the captured image used in the previously generated reference map and determines the need to update the reference map based on the difference image, or the like. In the content server 20, the generation/update detection unit 80 may also detect the need to generate or update the reference map based on the viewpoint information and the content of the user operation acquired by the terminal information acquisition unit 50.

In the image processing device 10, the generation/update detection unit 80 similarly detects the need to generate or update the reference map based on the change in the captured image or sensor output data acquired by the input information acquisition unit 62, viewpoint information, and the content of the user operation. The generation/update detection unit 80 may not only detect actual changes in the display target, but may also predict the occurrence of changes. For example, the generation/update detection unit 80 may predict the object in which a change will occur and the time at which the change will occur, based on the content of previous user operations, captured images, sensor output data, program specifications, the passage of time, or the like.

When the generation/update detection unit 80 detects the need to generate or update the reference map, the target tile determination unit 82 determines the tile of the reference map to be generated or updated. The target tile determination unit 82 identifies the area where changes have occurred in the color of the image, the unevenness of the subject, the material, or the like, based on, for example, the above-mentioned differential image, and determines the tile including that area as the update target.

When the reference map includes the hierarchical data, the target tile determination unit 82 may compare the level of detail corresponding to each layer with the magnitude of changes that have occurred in the captured image or object, or the like, to limit the layer to be generated or updated. For example, in the image of the moon illustrated in FIG. 2, it is desirable to illustrate the movement of a probe on the lunar surface in detail when the viewpoint is near the lunar surface, but it does not need to be illustrated in a distant view overlooking the entire moon. Therefore, the target tile determination unit 82 determines the layer corresponding to the level of detail of the change detected by the generation/update detection unit 80, and then identifies the tile in the area where that change appears.

The target tile determination unit 82 may also select which reference map to generate or update from among multiple types of reference maps. For example, when the probe moves across the lunar surface, the sand on the lunar surface changes in unevenness due to ruts, but the color value and material of the sand do not change. In this case, the target tile determination unit 82 will update only the height map among the reference maps. Note that in a case of generating the reference map for the first time, when changing the angle of view of the reference map itself, or when adding the additional reference map described above, the target tile determination unit 82 may naturally generate tiles across all layers and areas regardless of parameters.

The tile data generation unit 84 generates and updates data for tiles that the target tile determination unit 82 has determined to be the target for generation or updating. When the generation/update detection unit 80 predicts the need to generate or update the reference map, the tile data generation unit 84 speculatively generates and updates the data for the target tile and stores the data separately until the need actually arises. This allows for faster generation and updating of the actual reference map.

As described above, the tile data generation unit 84 updates only the tile with the necessary parameter, layer, and area based on various information. By updating only localized data in this way, the impact on display delays can be minimized even when the update process per tile takes a certain amount of time, thereby maintaining the quality of the entire reference map. Furthermore, by providing the reference map generation units 54 and 74 in each of the content server 20 and the image processing device 10, it is possible to achieve both the immediacy of completing processing within the image processing device 10 and the stability of quality provided by the abundant processing resources of the content server 20.

Furthermore, the system in which information such as the captured image and sensor output data acquired by the content server 20 and multiple image processing devices 10 is finally aggregated into the reference map generated by the content server 20 can significantly increase the diversity of content. However, the present embodiment is not limited to this configuration, and the reference map generation unit may be provided in only one of the content server 20 and the image processing device 10, and the information used to generate and update the reference map need not be shared.

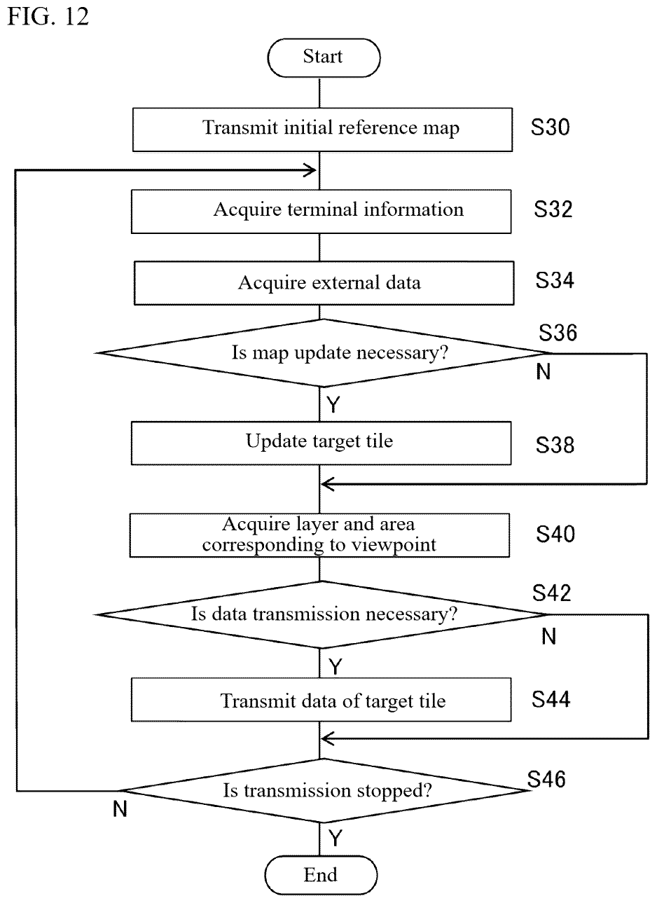

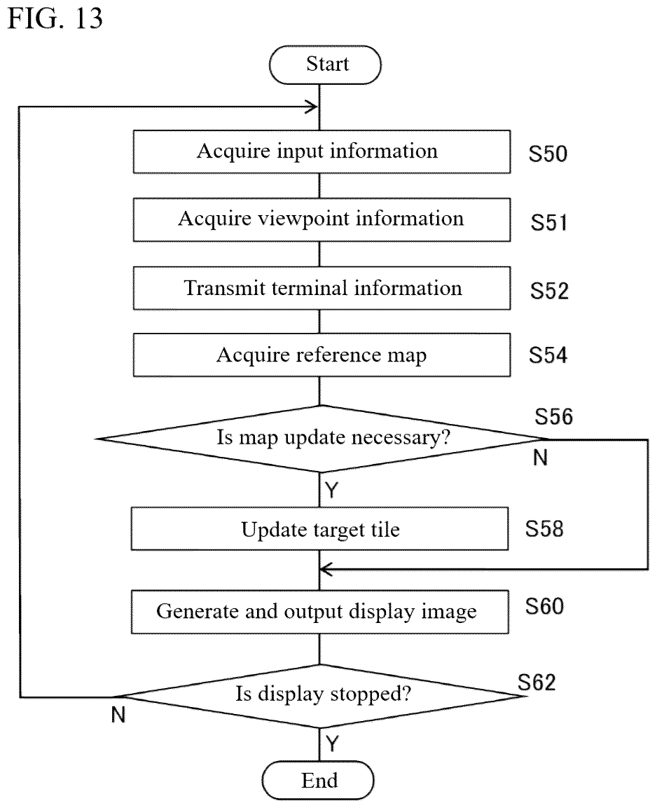

Next, the operation of the image processing system realized by the above configuration will be described. FIG. 12 is a flowchart illustrating the processing procedure in which the content server 20 generates and updates the reference map while transmitting necessary data to the image processing device 10. This flowchart begins, for example, when the image processing device 10 and content server 20 establish communication and the user requests the start of image display on the image processing device 10, for example by selecting an application. Note that the illustrated processing steps may actually be performed in parallel. The same applies to the flowchart illustrated in FIG. 13.

It is also assumed that the reference map storage unit 58 of the content server 20 stores initial data of the reference map. First, the reference map transmission unit 60 of the content server 20 transmits a portion of this initial data to the image processing device 10 (S30). The terminal information acquisition unit 50 acquires the terminal information, such as the viewpoint information and user operation details, from the image processing device 10 (S32). The terminal information acquisition unit 50 may also acquire the image captured on the image processing device 10 side or sensor output data.

Meanwhile, the external data acquisition unit 52 acquires external data that affects the reference map, such as the captured image and sensor output data that the content server 20 can acquire separately (S34). The reference map generation unit 54 checks whether the reference map needs to be updated based on the information acquired in S32 and S34 (S36). When it is determined that the update is necessary (Y in S36), the reference map generation unit 54 identifies the tile that need to be updated from the reference map stored in the reference map storage unit 58 and updates the data for the tile as appropriate (S38). The reference map generation unit 54 may also newly generate the additional reference map in response to the appearance of the object, or the like.

When the reference map does not need to be updated, the process of S38 is skipped (N in S36). Next, the transmission data identification unit 56 identifies the layer and area of the reference map that corresponds to the viewpoint information acquired in S32 (S40). Here, the layer and area corresponding to the viewpoint information may include not only the layer and area corresponding to the image currently being displayed on the image processing device 10, but also a predetermined range of layers and areas nearby.

The larger the range of the reference map transmitted to the image processing device 10, the more accurately the display image can be generated to accommodate sudden movements of the viewpoint or line of sight, but this puts a strain on the storage capacity of the image processing device 10. By providing the reference map generation function within the image processing device 10 and making it possible to accommodate a certain degree of viewpoint and eye movement, a stable display can be maintained even when the layer and area of the reference map to be transmitted from the content server 20 are limited.

For example, the transmission data identification unit 56 stores, in an internal memory thereof, a lookup table that associates the viewpoint information with the layer and area of the corresponding reference map. The corresponding layer and area are identified by referencing the lookup table based on the actual viewpoint information transmitted from the image processing device 10. Alternatively, the transmission data identification unit 56 may perform simple rendering based on the actual viewpoint information transmitted from the image processing device 10 to identify the corresponding layer or area of the reference map for each area of the image plane. In this case, the transmission data identification unit 56 may use well-known techniques such as proxy rendering or sampler feedback.

The transmission data identification unit 56 checks whether or not there is any new data to be transmitted to the image processing device 10 from among the layer and area identified in S40 (S42). For example, the transmission data identification unit 56 checks whether there is any layer or area that is missing from the data previously transmitted to the image processing device 10, from among the layer and area corresponding to the viewpoint information. Alternatively, the transmission data identification unit 56 checks whether there is any layer or area that has been updated from among the data previously transmitted to the image processing device 10.

If there is a deficiency or an update, the transmission data identification unit 56 determines that there is new data to be transmitted and identifies the tile for the area (Y in S42). The reference map transmission unit 60 then transmits the data for the identified tile to the image processing device 10 (S44). When there is no new data to be transmitted, the processing of S44 is skipped (N in S42).

In a case where there is no need to stop the data transmission, for example when the image processing device 10 notifies the user of the user operation to stop display (N in S46), the content server 20 repeats the processes in S32 to S44. When it becomes necessary to stop the data transmission, the content server 20 terminates processing (Y in S46). However, the content server 20 may continue to update the reference map in preparation for transmitting the reference map to other image processing devices 10 or in preparation for future reference map transmission needs.

FIG. 13 is a flowchart illustrating the processing procedure by which the image processing device 10 generates and outputs the display image based on the reference map. Here, it is assumed that initial data of the reference map is stored in the reference map storage unit 70 of the image processing device 10, and the initial image is displayed on the display device 16. First, the input information acquisition unit 62 of the image processing device 10 acquires at least one of input information such as the content of the user operation, the position and orientation of the head-mounted display, the captured image, and the sensor output data via the input device 14 (S50).

Next, the viewpoint information acquisition unit 64 acquires the viewpoint information based on the user operation and information about the position and orientation of the head-mounted display (S51). The terminal information transmission unit 66 transmits the terminal information such as the viewpoint information and the content of the user operation to the content server 20 (S52). The terminal information transmission unit 66 may also transmit information such as the captured image acquired in S50 and the sensor output data to the content server 20 as appropriate.

As described above, the viewpoint information acquisition unit 64 may identify the layer and area of the reference map that corresponds to the viewpoint information, and the terminal information transmission unit 66 may transmit information about the layer and area to the content server 20. In this case, the viewpoint information acquisition unit 64 stores, in the internal memory, a lookup table similar to that described above for the transmission data identification unit 56 of the content server 20, and references the lookup table to identify the layer and area corresponding to the actual viewpoint information. Alternatively, the viewpoint information acquisition unit 64 may identify the corresponding layer and area by performing simple rendering based on the actual viewpoint information.

When the image processing device 10 transmits the viewpoint information, the content server 20 identifies the corresponding layer and area of the reference map based on the viewpoint information. When the image processing device 10 transmits information on the layer and area of the reference map corresponding to the viewpoint information, the content server 20 can use this information as is to identify the need for data transmission and the tile to be transmitted. The aspect to be used may be determined in advance based on processing capacity, or the like, through a handshake between the image processing device 10 and the content server 20, or it may be possible to switch between them mid-display depending on the level of processing pressure, predetermined switching conditions set in the content to be displayed, or the like.

Next, the reference map acquisition unit 68 acquires the reference map data on a tile-by-tile basis from the content server 20 and stores the reference map data in the reference map storage unit 70 (S54). However, when no data is transmitted from the content server 20, processing in S54 is skipped. Meanwhile, the reference map generation unit 74 checks, based on the information acquired in S50, whether the reference map stored in the reference map storage unit 70 needs to be updated (S56). When it is determined that the update is necessary (Y in S56), the reference map generation unit 74 identifies the tile that needs to be updated from the reference map stored in the reference map storage unit 70, and updates the data of the tile as appropriate (S58).

Similar to the reference map generation unit 54 of the content server 20, the reference map generation unit 74 may also generate the additional reference map in response to the appearance of the object, or the like. When the update of the reference map update is not necessary, processing in S58 is skipped (N in S56). By the processing of S58, even when the existing reference map needs to be updated due to a recent viewpoint movement or user operation, or when the update is missing, the reference map can be kept up to date without waiting for the transmission of data from the content server 20.

Next, the display image generation unit 76 references the reference map, generates the display image corresponding to the viewpoint information, and outputs the display image to the display device 16 (S60). When there is no need to stop the display due to user operation or the like (N in S62), the image processing device 10 repeats the processing of S50 to S60. When there is the need to stop the display, the image processing device 10 terminates the processing (Y in S62).

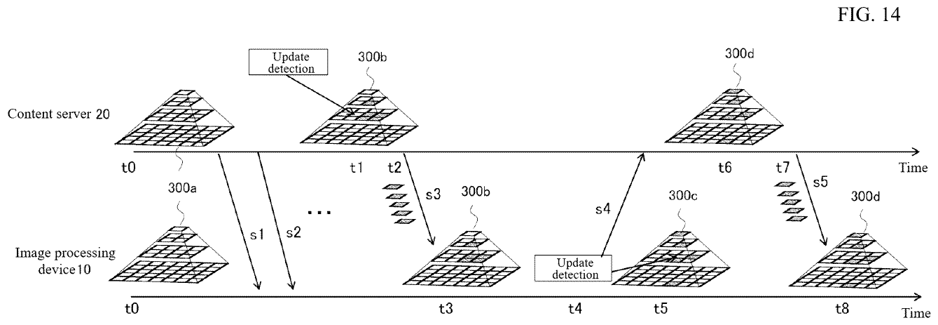

FIG. 14 schematically illustrates the transition of the reference map when the reference map generation unit is provided in both the content server 20 and the image processing device 10. The horizontal axis of the drawing is the time axis, with the upper row representing the transition of the reference map held by the content server 20 and the lower row representing the transition of the reference map held by the image processing device 10. Note that in the drawing, the reference maps are all represented as hierarchical data of the same size, but, as mentioned above, the reference map held by the image processing device 10 may be a portion of the reference map held by the content server 20.

First, at a time t0, the content server 20 and the image processing device hold a reference map 300a, which represents common content. In this state, the image processing device 10 generates the display image using the reference map 300a. When the viewpoint information of the image processing device 10 changes, the content server 20 appropriately transmits data for newly required tile to the image processing device 10, as indicated by arrows s1, s2. Although not illustrated in the drawing, this processing is repeated in subsequent periods.

When the need to update the reference map is detected based on the user operation or newly acquired captured images, the content server 20 updates the reference map a tile-by-tile basis at a time t1. Here, the “user operation” may include, for example, operations by another user in the same virtual space. In the drawing, the five tiles to be updated in the updated reference map 300b are shaded.

At a time t2 immediately after the update, the content server 20 transmits data for the tiles to be updated in the reference map 300b to the image processing device 10, as indicated by an arrow s3. However, the tile in layer or area that do not correspond to the viewpoint information of the image processing device 10 may be excluded from the data to be transmitted. At a time t3, the image processing device 10 replaces the tile to be updated in the reference map 300a held by the image processing device 10 with the transmitted data. As a result, the image processing device 10 generates the display image using the updated reference map 300b.

Next, when the image processing device 10 detects the need to update the reference map based on the user operation, newly acquired captured images, or the like, the image processing device 10 transmits this information to the content server 20 at a time t4, as indicated by an arrow s4. Immediately thereafter, at a time t5, the image processing device 10 regenerates the tile to be updated in the reference map 300b held by the image processing device 10. As a result, the image processing device 10 generates the display image using the updated reference map 300c.

Meanwhile, at a time t6, the content server 20 updates the reference map a tile-by-tile basis based on the data affecting the reference map transmitted from the image processing device 10. Immediately thereafter, at a time t7, the content server 20 transmits the data for the tile to be updated in the updated reference map 300d to the image processing device 10, as indicated by an arrow s5. At a time t8, the image processing device 10 replaces the tile to be updated in the reference map 300c held by the image processing device 10 with the transmitted data. As a result, the image processing device 10 generates the display image using the updated reference map 300d.

As such, in the present embodiment, the content server 20 and the image processing device 10 basically share the reference map representing the same content. Here, the image processing device 10 not only waits for data transmission from the content server 20, but also updates the reference map itself, thereby realizing the display system that can be completed within the image processing device 10 and can immediately respond to changes in the user operation and viewpoint information without changing the display image generation process itself.

Note that the reference map 300c updated by the image processing device 10 at the time t5 may be different from the reference map updated by the content server 20 at the time to based on the same information, and further from the reference map 300d updated at the time t8. For example, at the time t5, the image processing device 10 may prioritize low latency and update only the minimum number of tiles necessary, such as a low-resolution layer, and then at the time t6, the content server 20 may complete a more detailed reference map and transmit the reference map to the image processing device 10.

Although the drawings primarily focus on the processing of updating the reference map already stored, the image processing device 10 may also generate the reference map even when the reference map held by the image processing device 10 is insufficient. For example, when a user experiencing virtual reality using a head-mounted display suddenly turns around, the area of the reference map required to generate the display image may change significantly, and the reference map data previously stored may not be sufficient.

In this case, the image processing device 10 generates the reference map to compensate for the lack of information in response to changes in viewpoint information, and generates a display image based on the reference map. The viewpoint information is transmitted to the content server 20, and eventually the corresponding reference map is transmitted, but the image processing device 10 can instantly generate only the necessary reference maps, allowing the field of view of the display image to be changed appropriately without waiting for the data transmission from the content server 20. In this case, the image processing device 10 may also prioritize low latency and generate only low-resolution layers.

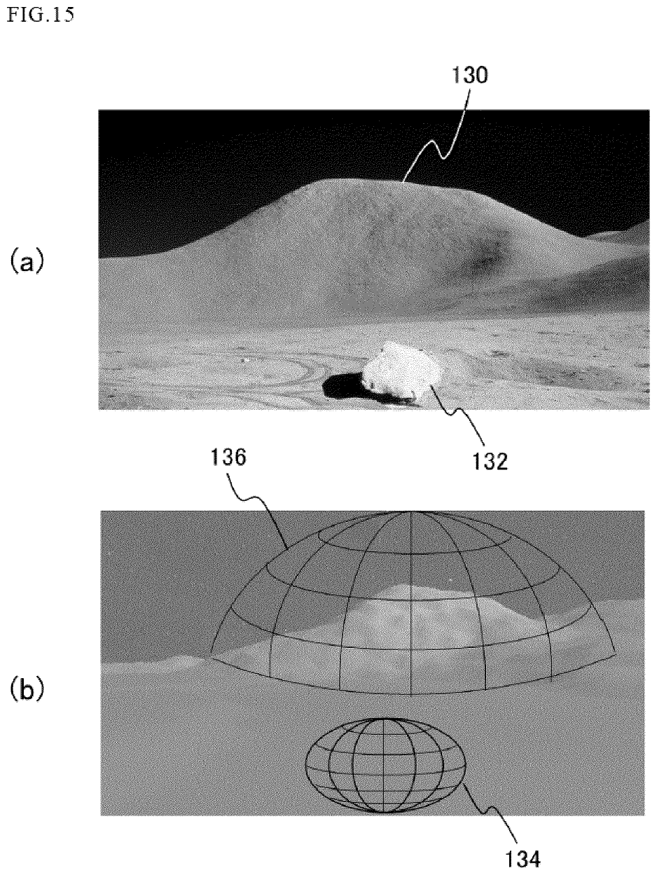

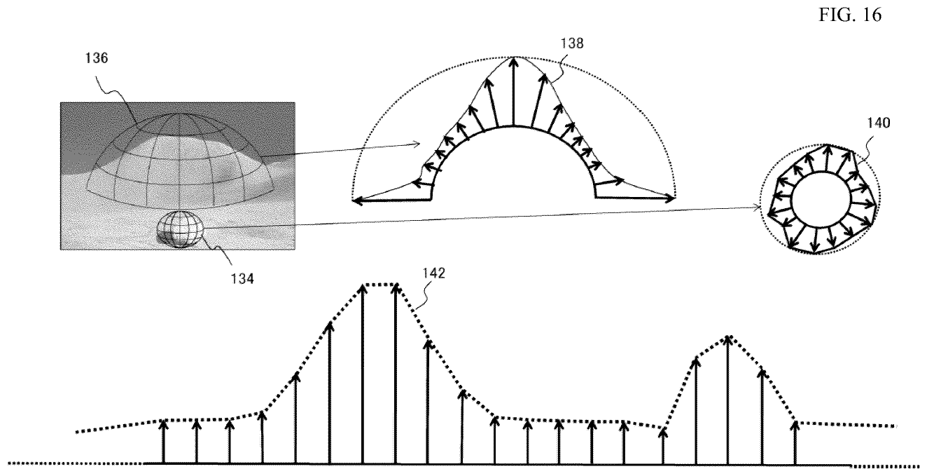

FIG. 15 is a diagram illustrating an aspect of generating the display image using multiple reference maps. Here, the three-dimensional object of the display target is the moon, as in FIGS. 2 and 3. (a) illustrates an example of the display image when the viewpoint approaches further from the situation illustrated in (c) of FIG. 2 and reaches the vicinity of the lunar surface. In this case, in addition to a hill 130 illustrated in (c) of FIG. 2, a rock 132 is clearly visible.

As illustrated in FIG. 8, the height map defines the height in the normal direction of the three-dimensional surface of the basic shape such as a sphere, so that the hill 130, which is a simple elevation in the height direction, can be expressed by the height map. Meanwhile, a part such as the rock 132, which is in contact with or connected to the solid of the basic shape, but has a surface facing the solid surface of the basic shape, cannot be fully expressed by the height map.

Therefore, in the present embodiment, by dividing the model data and reference maps by shape, even for a single three-dimensional object, the flexibility of the shapes that can be represented by the height map is increased. In the illustrated example, as illustrated in (b), model data 134 and a reference map for representing the three-dimensional object of the rock 132 are prepared separately from lunar data.

Since the shape of rock 132 is only visible when the viewpoint is close, whether or not to combine the model data 134 is preferably switched depending on the distance of the viewpoint. For example, as illustrated in (a) and (b) FIG. 2, in a distant view, the display image is rendered using only the reference map of the moon, and when the viewpoint is close, as illustrated in FIG. 15, the model data 134 and reference map of the rock 132 are read and incorporated into the rendering processing.

Specifically, the basic shape of rock 132 is disposed on the lunar surface, and the height map is used to identify the pixel where the ray reaches the rock 132, and the pixel value for the pixel is determined using the reference map of the rock. In this way, the rock 132 can be expressed more realistically when viewed from up close. Similarly, model data 136 and a reference map can be prepared for the hill 130, allowing it to be expressed in more detail than the overall lunar data. The calculation of a well-known Constructive Solid Geometry (CSG) model can be used to combine the basic shapes themselves.

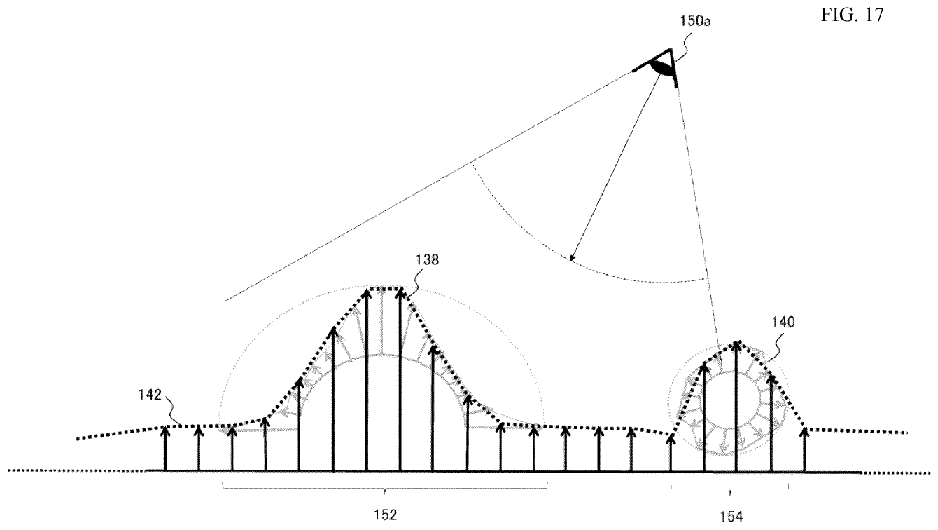

FIG. 16 is a diagram exemplifying a reference map prepared in an aspect in which multiple model data are used in combination. As in FIG. 15, when the display target is the moon, first, the height map 142 for the entire lunar surface and the reference map of the corresponding color value or the like are prepared. Furthermore, the model data 134 for the rock 132 and the model data 136 for the hill 130 illustrated in FIG. 15 are prepared. Specifically, the basic shape (sphere in the drawing) representing the rock is associated with the size and position of the rock, and the height map 140 and the reference map of the corresponding color value or the like are prepared. Furthermore, the basic shape (hemisphere in the drawing) representing the hill is associated with the size and position of the hill, and the height map 138 and the reference map of the corresponding color value or the like are prepared.

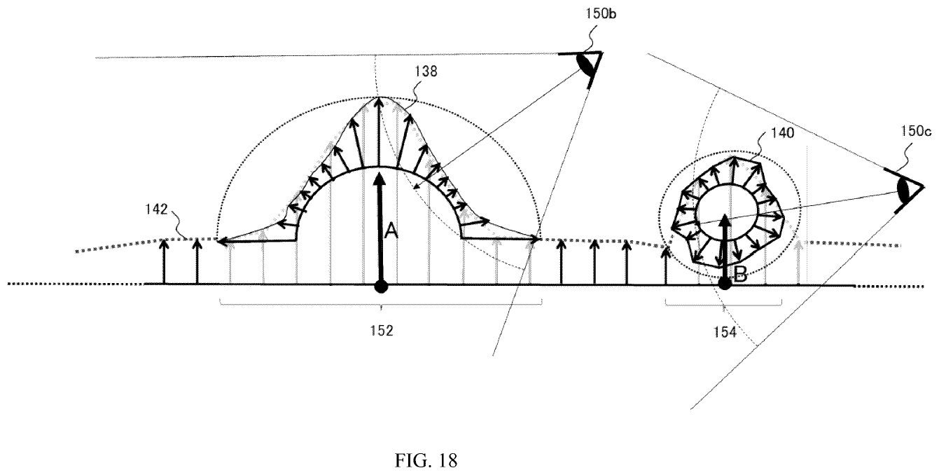

FIGS. 17 and 18 are diagrams for explaining switching of the reference maps in response to changes in viewpoint in the aspect in which the multiple model data are used in combination. When model data for the hill and rock is prepared separately as illustrated in FIG. 16, the height maps 138 and 140 will be set overlappingly in the hill 152 and rock area 154 of the height map 142 for the lunar surface.

As illustrated in FIG. 17, when the viewpoint 150a is located equal to or more than a predetermined distance from the lunar surface, the image processing device 10 renders the display image by activating the height map 142 for the lunar surface and the reference map of the corresponding color value or the like. In the drawing, the separately prepared height maps 138 and 140 are illustrated lightly, indicating that the height maps are invalid. Even in this case, by utilizing the hierarchical structure, it is possible to dynamically express the unevenness of the surface as the viewpoint approaches.

Meanwhile, as illustrated in FIG. 18, when a viewpoint 150b enters a predetermined range of the hill 152, the image processing device 10 renders the display image by activating height map 138 of the hill and the reference map of the corresponding color value or the like. In practice, the image processing device 10 places a model of the hill by referencing data such as the basic shape, position, and size of the hill, and then references the reference maps during ray tracing.

Similarly, when a viewpoint 150c enters a predetermined range of the area 154 of the rock, the image processing device 10 places the model of the rock and then uses the height map 140 and the reference map of the corresponding color value or the like to render the display image. In the drawing, the hill 152 and rock area 154 in the height map 142 for the lunar surface are lightly drawn to indicate that these portions are invalid. This allows for more precise representation of the hill and rock than when only the height map 142 for the lunar surface is used. For example, when viewing the rock from the side, as at the viewpoint 150c, the gap between the lunar surface and the rock can be accurately represented.

Furthermore, in the present embodiment, by using the hierarchical structure for the reference map, even large changes in magnification can be seamlessly represented, but increasing the maximum resolution increases the data size and takes time to access the data during the transmission processing and loading processing. For this reason, by limiting the maximum resolution of the reference map for the entire moon to a certain extent and preparing the reference maps with higher resolution locally as needed, such as for the hill and rock, it is possible to reduce data size and improve processing efficiency while maintaining quality. Furthermore, by preparing the reference map separate from the moon for the moving object such as the lunar surface probe, the reference map can be updated efficiently to match the movement.

Hereafter, a main model that represents the entire three-dimensional object of the display target, such as the moon, will be called the “base model”, and a partial model that is combined with the model, such as the rock and hill, will be called a “part model”. The reference map for the part model may be prepared with a single resolution, or, like the base model, the reference model may be the hierarchical data with multiple resolutions. Here, it is convenient to define the viewpoint distance that triggers switching to the part model and the switched area in the three-dimensional space that defines the hierarchical structure of the reference map of the base model. In FIG. 18, this switching is indicated by arrows A and B.

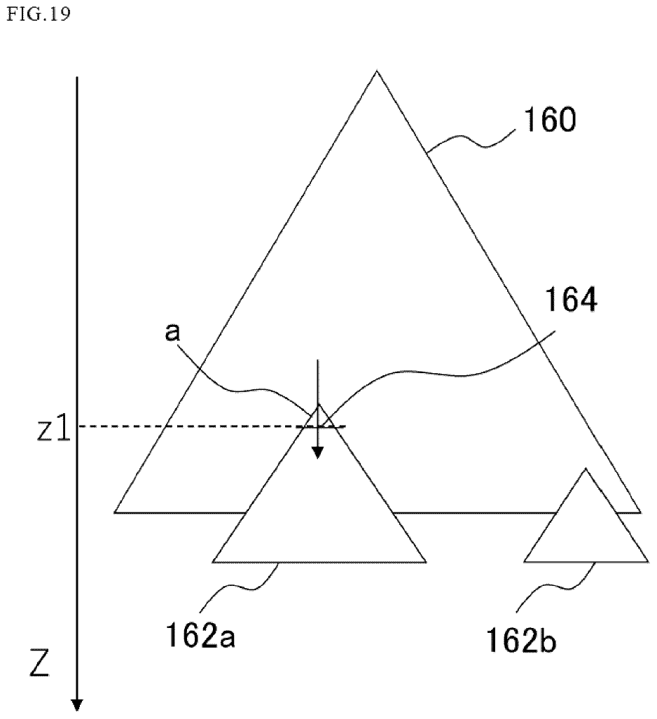

FIG. 19 is a diagram illustrating a method for defining switching between the base model and the part model. In the drawing, three triangles represent hierarchical data 160 of the reference map of the base model and hierarchical data 162a and 162b of the reference maps of the two part models. In reality, the hierarchical data 160, 162a, and 162b each have a configuration in which reference maps with different resolutions are discretely disposed in the Z-axis direction of the drawing, as illustrated in FIG. 5.

The content server 20 and image processing device 10 determine the layer and area of the hierarchical data of the reference map that corresponds to the viewpoint information based on the positional relationship between the viewpoint and the layer in the three-dimensional space defined by the hierarchical data. In the present embodiment, the hierarchical data 160 of the base model and the hierarchical data 162a and 162b of the part model are set in the three-dimensional space in an overlapping state as illustrated in the drawing.

Here, while rendering the display image using the hierarchical data 160 of the base model, when the viewpoint approaches the object and moves as indicated by an arrow a, the hierarchical data 162a of the part model becomes included in the data corresponding to the viewpoint information. As a result, the content server 20 includes the hierarchical data 162a of the part model in the data to be transmitted to the image processing device 10, and the image processing device 10 generates the display image while also referencing the hierarchical data 162a.

As the viewpoint moves as indicated by the arrow a, a small portion of the display image rendered using the reference map of the base model is replaced with an image rendered using a relatively low-resolution reference map of the part model. As the viewpoint moves closer still, a larger portion of the display image is rendered using the high-resolution reference map of the part model. Furthermore, when the viewpoint moves in the opposite direction to the arrow a, the display image will naturally be rendered using only the reference map of the base model.

In the object being displayed, the layer and area that servers as a trigger for switching the reference destination to the reference map of another model are set in advance as “link information” represented by a line 164 in the drawing. In the example illustrated in drawing, switching from the hierarchical data 160 to the hierarchical data 162a occurs in the area represented by the line 164 in the layer where Z=z1. Hereinafter, this switching of reference maps will be referred to as a “link”. There is no limit to the number of part models in which the link is set to hierarchical data 160 of the base model.

Furthermore, a link to another part model may be set in the hierarchical data 162a of the part model. As described above, each of the hierarchical data 160, 162a, and 162b is associated with information necessary for rendering, such as the basic shape and size. This allows the image processing device 10 to generate the display image while switching the reference map. As described above, a similar link structure can be used even when the reference map of the part model is not hierarchically structured.

The illustrated example illustrates a link structure that associates the same type of reference map, but similar principles can be used to associate different types of data. For example, instead of the reference map for the part model, different types of model data for rendering the part model may be associated. As an example, the part model is expressed by a procedural model, and a calculation expression or the like for expressing the part model by the procedural model is set in association with the link information of the line 164. This allows for flexible responses such as switching the representation method to a model that is suited to the physical properties of the enlarged part when the display magnification of the three-dimensional object being rendered using ray tracing with the reference map reaches a predetermined value.

Next, a method for generating the reference map that displays images with less latency when the display device 16 is a head-mounted display will be described. As described above, in the case of the head-mounted display, a pair of images for the left and right eyes are displayed with distortion in opposite directions to cancel out the distortion and chromatic aberration of the eyepiece lens. Hereinafter, the image with distortion corresponding to the eyepiece lens will be referred to as a “distorted image”.

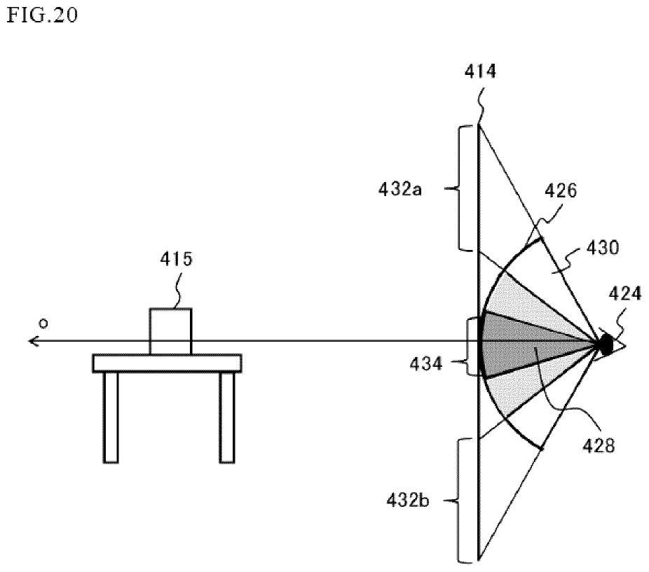

FIG. 20 illustrates the relationship between a general view screen and a screen corresponding to the distorted image. A view screen 414 is a screen for generating a general centrally projected image, while the screen 426 represents a screen for generating a distorted image by projection. The drawing illustrates both screens viewed from the side surface along with a viewpoint 424 of the user.

The view screen 414 is formed, for example, by a plane having an angle of view of approximately 120° centered on an optical axis o extending in the line of sight from the viewpoint 424. The image of the object 415 is displayed uniformly reduced at a scale that corresponds to the distance between the viewpoint 424 and the view screen 414, regardless of the vertical distance from the optical axis o. Meanwhile, the distorted image has properties similar to an image captured by a fisheye lens, and as a result, the screen 426 has a curved shape as illustrated. However, the detailed shape of the screen 426 depends on the lens design.

As is clear from the figure, the difference in area between the corresponding areas of the two screens is small in the angular range 428 near the optical axis o, but the difference in area increases as the angular range moves away from the optical axis o. Therefore, while there is almost no difference in image size between the centrally projected image and the distorted image in the central area 434 of the image, in the peripheral areas 432a and 432b, the image rendered using central projection is significantly reduced in the distorted image. In other words, it can be said that a portion of the centrally projected image generated using a general processing procedure contains unnecessary information that is not reflected in the display image.

Therefore, in the present embodiment, the content server 20 and image processing device 10 identify the displacement destination of each pixel on the view screen 414 due to lens distortion, and then directly render the distorted image by setting the color of the displacement destination as the pixel value of the corresponding pixel. This processing is conceptually equivalent to rendering the image on the screen 426, and as a result, a high-resolution image is generated in the central area and a low-resolution image is generated in the peripheral area. This characteristic is highly compatible with foveated rendering. The foveated rendering is a technology that takes advantage of the human visual characteristic that images outside the foveal region of the field of view appear blurred compared to the area corresponding to the fovea and reduces processing load and data volume by displaying the area near the gaze point at high resolution and the rest at low resolute.

The reference map generation unit 54 of the content server 20 and the reference map generation unit 74 of the image processing device 10 identify, for each pixel defined in a matrix on the view screen, the position to which the target pixel will be displaced when viewed through the lens, and determine the color value or various parameter values of the displacement destination as the pixel value of the reference map. The distribution of pixel displacement direction and displacement amount (hereinafter referred to as “displacement vector”) is acquired in advance according to the eyepiece lens implemented in the head-mounted display.

When the captured image is included in the display target, in a general central projection image in which distortion caused by the camera lens is corrected, information in the peripheral portion is wasted, as with the principle illustrated in FIG. 20. Therefore, the reference map generating units 54 and 74 can generate the reference map using the image before correction for distortion caused by the camera lens, thereby eliminating unnecessary corrections in both the captured image and the display image.

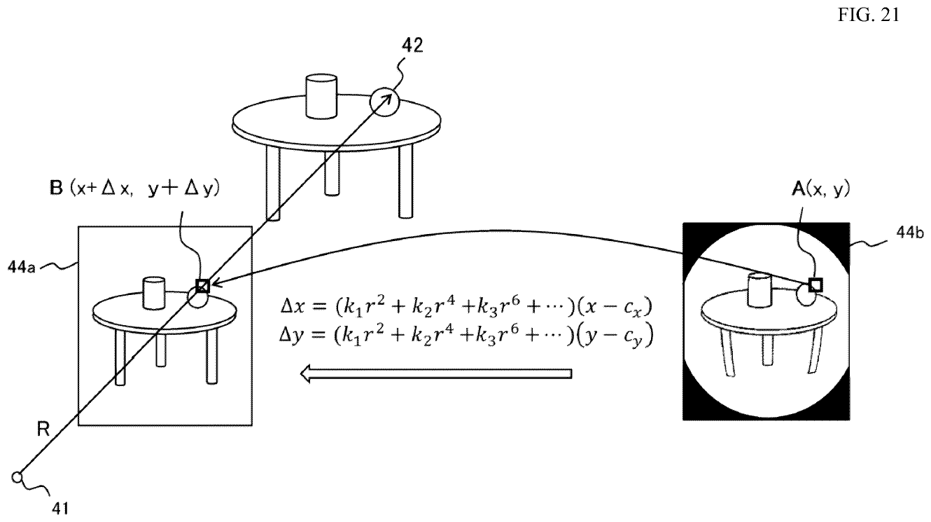

FIG. 21 is a diagram illustrating a method by which the reference map generation units 54 and 74 determine the pixel value for the reference map. In general ray tracing, as illustrated on the left side of the drawing, ray R is generated from the viewpoint 41, and the pixel value is determined through physical calculations that take into account the color and material of object 42 that the ray R reaches, the position of the light source, or the like. The image 44a generated in this manner is equivalent to the central projection image illustrated in FIG. 20. Meanwhile, in order to view the image 44a without distortion through the eyepiece lens in a head-mounted display, it is necessary to display the image 44b with distortion. In the present embodiment, the reference map to which the same distortion as the image 44b with distortion is given is directly generated.

In other words, the reference map generation unit 54, 74 calculates the position to which a target pixel A on the view screen will be displaced when viewed through the lens, and sets the pixel value of target pixel A to the parameter value obtained by the ray from the viewpoint 41 that passes through the pixel B of the displacement destination. The relationship between distorted image 44b and central projection image 44a is equivalent to the relationship between the captured image with distortion caused by a general camera lens and the image with the distortion corrected. Therefore, the displacement vector (Δx, Ay) for the target pixel at position coordinates (x, y) can be calculated using the following general formula.

$$[ Expression 1 ]$$

$$Δ x = ( {k}_{1} {r}^{2} + {k}_{2} {r}^{4} + {k}_{3} {r}^{6} + ⋯ ) ( x - {c}_{x} ) \qquad ( Equation 1 )$$

$$Δy = ( {k}_{1} {r}^{2} + {k}_{2} {r}^{4} + {k}_{3} {r}^{6} + ⋯ ) ( y - {c}_{y} )$$

Here, r is the distance from the optical axis of the lens to the target pixel, and (Cx, Cy) is the position of the optical axis of the lens. Furthermore, k₁, k₂, and k₃ are lens distortion coefficients that depend on the lens design. The degree of correction is not particularly limited. Furthermore, this is not intended to limit the correction expression used in the present embodiment. The reference map generation units 54 and 74 calculate a displacement vector (Δx, Δy) for the position coordinates (x, y) of the target pixel A using Equation 1, and determine the pixel value of the target pixel A by the ray tracing for the pixel B at position coordinates (x+Δx, y+Δy) which is the displacement destination. Moreover, the generation of the reference map can be made faster by calculating the displacement vector in advance and preparing the displacement vector as a map.

When the reference map with the distortion like this, the distortion depends on the position of the optical axis, that is, the viewpoint information. Therefore, the reference map generation unit 54 of the content server 20 generates and updates the reference map for each image processing device 10 based on the viewpoint information transmitted from the image processing device 10. By providing the distortion for the head-mounted display which is the display destination at the stage of the reference map, the generation and transmission of the reference map, as well as the generation of the display image, can be pipelined in units smaller than the field of view of the display image, enabling low-latency display. In addition, by increasing the amount of information in the foveal area and reducing the amount of information in the area of the peripheral portion, the transmission of unnecessary data can be avoided.

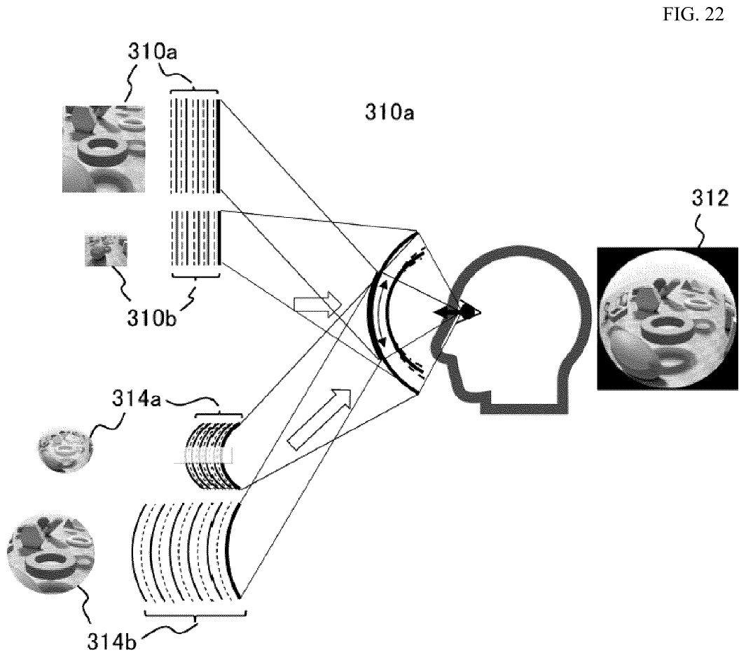

FIG. 22 is a diagram illustrating the configuration of the reference map when implementing the foveated rendering. In the general foveated rendering, the low-resolution image 310b of the entire area and the high-resolution image 310a of the central area are generated and combined using the central projection. Generally, a series of processes such as image combination, distortion correction, and display are performed sequentially, and thus, the frame rate is naturally the same for all of them. In the drawing, the display timing of each image frame is illustrated by a series of vertical lines with the horizontal axis as the time axis. For example, in the case of 60 fps, images are generated and displayed at the timings indicated by the solid lines, and in the case of 120 fps, images are generated and displayed at the timings indicated by the solid and dashed lines.

Meanwhile, in the present embodiment, since the generation process is performed in two stages such as the reference map and the display image, by preparing the reference map for each area, it is possible to combine various frame rates and the presence or absence of distortion. For example, the reference map corresponding to the entire area image 314a having low resolution and the reference map corresponding to the central area image 314b having high resolution rendered with distortion using the method described above. Here, the “central area” refers to the area within a predetermined range from the center of the image plane, the area within a predetermined range from the point (gaze point) where the lines of sight intersect on the image plane, or, the area within the predetermined range from the optical axis if the eyepiece lens is taken into account.

The reference map with the distortion inherently has the characteristic of having high resolution in the central area, but by using a reference map of a different layer for each area, it is possible to achieve efficiency by further reducing the resolution of the reference map for the entire area. In addition, when generating the display image, the display image 312 with distortion can be easily generated.

It is also known that human vision is highly sensitive to motion in the area outside the fovea. Therefore, by setting the frame rate of the reference map corresponding to the image 314 of the central area lower than the frame rate of the reference map corresponding to the entire area image 314a, it is possible to generate a high-quality display image while suppressing the data size of the reference map small. In this case, based on the viewpoint information transmitted from the image processing device 10, the content server 20 generate the reference map corresponding to the entire area image 314a at a low resolution and a high frame rate, and the reference map corresponding to the central area image 314b at a high resolution and a low frame rate, and transmits the reference maps to the image processing device 10. As described above, the image processing device 10 may itself generate similar reference maps in accordance with changes in the viewpoint information.

According to the principle described in FIG. 20, unnecessary information is unlikely to be generated for the central area, even in the central projection image. Therefore, the reference map generation units 54 and 74 may generate the reference map for the central area that corresponds to the high-resolution image 310a of the central projection, and the reference map for the entire area that corresponds to the low-resolution image 314a with distortion. Furthermore, the reference map for the entire area may be data that omits only the central area, further improving processing efficiency.

When the display image does not need to be distorted according to the eyepiece lens, such as when the display device 16 is a flat-panel display, the reference map may also be the central projection. In this case, the display image generation unit 76 generates the display image using the reference map of the high-resolution layer, with the center area being the center of the display image or a predetermined range from the gaze point of the user, and generates the outside area using the reference map of the low-resolution layer. Alternatively, as described above, a high-resolution reference map from the central projection may be used for the central area, and a low-resolution reference map with distortion may be used for the surrounding areas after coordinate conversion.

In this case, too, the frame rate of the reference map for the peripheral area may be higher than that of the reference map for the central area. Alternatively, the resolution may be the same regardless of the area, with only the frame rate being different. Moreover, in the explanation of FIG. 22, the focus is mainly on the aspect in which the reference map generation units 54 and 74 generate the reference map each time based on the viewpoint information, but when using the reference map of the central projection or when the viewpoint information does not change, it is naturally sufficient to simply select and transmit tile data for different layers and areas from the existing reference map for each area of the display image plane. Furthermore, the display image plane may be divided not only into two areas such as the central area and the outer area, but also into three or more areas, with differences in at least one of the resolution, frame rate, and the presence or absence of distortion.

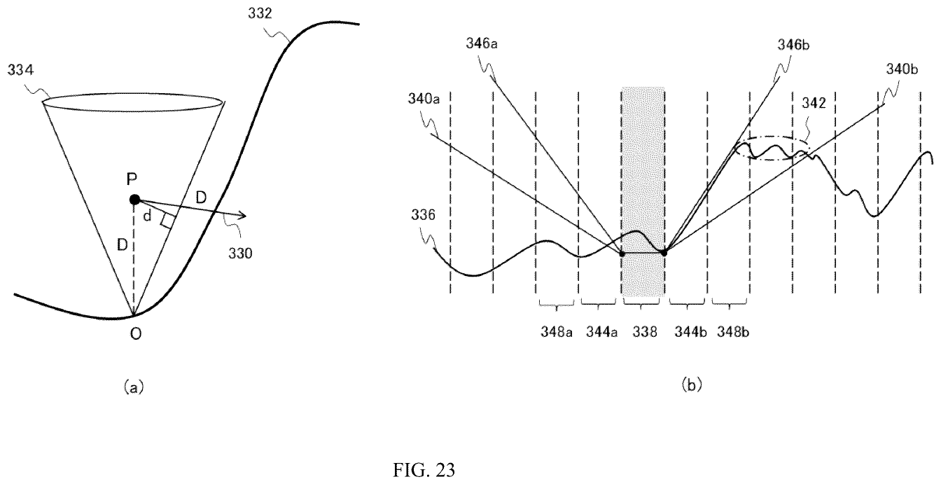

FIG. 23 is a diagram illustrating an aspect in which the distribution of shrink factors used in the ray marching is represented as the reference map. As described above, in the present embodiment, the distance from the ray to the object required for the ray marching is acquired from the height value represented by the height map. (a) illustrates a side view of a positional relationship between an object surface 332 and a ray arrival point P at a given time. Based on the height map, a distance D from the ray arrival point P to the object surface 332 is obtained. When the ray is advanced by the distance D in the direction indicated by an arrow 330, in the example illustrated in the drawing, the steep gradient of the object surface 332 will cause the ray to pass through the object surface 332, and it is possible that an accurate destination value will not be obtained.

One possible solution is to multiply the distance D by a coefficient smaller than 1 to reduce the ray advance width by a predetermined percentage. This method is disclosed, for example, in “A Note on Ray Marching with Heightfields”, [online], Oct. 18, 2019, [searched Jun. 26, 2023], Internet URL: https://www.peterstefek.me/ray-marching-heightfields.html. In this method, first, an inverted cone 334 is set whose vertex is the position O on the object surface 332, which corresponds to the ray arrival point P, that is, where point P is located in the height direction, and whose side surfaces do not touch the object surface 332.

When the length d of the perpendicular from the point P to the side surface of inverted cone 334 is defined as the ray advance width, it is guaranteed that the ray will not pass through the object surface 332. In this case, the coefficient (shrink factor) S by which the distance D is multiplied is d/D. When the slope of the side surface of the inverted cone 334 is defined as the maximum value c of the gradient of the object surface 332, the shrink factor S can be calculated as follows.

$$[ Expression 2 ]$$

$$S = \frac{1}{\sqrt{1 + {c}^{2}}} \qquad ( Equation 2 )$$

Determining a single shrink factor based on the maximum value c of the gradient across the entire object surface 332 ensures that the ray will not pass through the object surface 332, regardless of the area selected as the display target. However, in this case, the ray advance width will be excessively reduced even in flat areas, reducing rendering efficiency.

Therefore, in the present embodiment, the reference map with the shrink factor set for each tile in each layer is generated, allowing the ray advance width to be controlled with fine granularity to match the local unevenness of the object surface. However, when the maximum gradient c of the object surface is determined on a tile-by-tile basis, there is still a possibility that the ray will pass through the object surface when there is an even larger gradient in an adjacent tile area.

Setting a safe inverted cone while taking into account the gradient of the object surface in the surrounding tile area requires a large amount of calculation. Accordingly, in the present embodiment, the vertex of the inverted cone determined by the maximum gradient c on a tile-by-tile basis is moved to the boundary line of the tile area, and whether or not the object surface in an adjacent tile area falls within the inverted cone is checked. When the object surface falls within the moved inverted cone, the range for determining maximum gradient c is expanded so that the object surface no longer falls within the inverted cone.

(b) illustrates a cross-section of the object surface 336, with vertical dotted lines representing the boundary surfaces of the tile area. The reference map generation units 54 and 74 of the content server 20 and image processing device 10 first calculate the maximum value of the gradient on the object surface within the target tile 338 that acquires the shrink factor and on the boundary lines, and set a temporary inverted cone as illustrated in (a). The reference map generation units 54, 74 then shift the vertex of the inverted cone to the boundary surface of the target tile 338. The drawing illustrates the outermost side surfaces 340a and 340b of the cone after shifting.

The reference map generation units 54 and 74 check whether the object surface 336 is located inside the side surfaces 340a and 340b. In the illustrated example, a portion 342 of the object surface 336 is located inside the side surfaces 340a and 340b. In this case, the reference map generation units 54 and 74 obtain the maximum value of the gradient of the object surface in the area including the target tile 338, adjacent tiles 344a and 344b, and their boundary lines, and correct the slope of the cone side surface accordingly. Qualitatively, the presence of a steep gradient nearby increases the maximum value of the gradient and the slope of the cone side.

The drawing illustrates the outermost side surfaces 346a and 346b of the modified cone. The reference map generation units 54 and 74 check whether the object surface 336 is still located within the side surfaces 346a and 346b. In the drawing, the object surface 336 is not located within the side surfaces 346a and 346b. In other words, the maximum value of the gradient of the object surface that defines the cone side surface prevents the object surface in areas other than the target tile 338 from interfering with the calculation of the ray marching.

When the object surface 336 is still located inside the side surfaces 346a and 346b, the reference map generation units 54 and 74 obtain the maximum value of the gradient of the object surface within the adjacent tiles 348a and 348b further outward and in the extended range toward the boundary line, and corrects the slope of the cone side surface accordingly. This processing is repeated until the object surface 336 no longer falls inside the cone side.

This ultimately makes it possible to calculate a gradient c, which defines the range within which the slope of nearby object surface does not interfere with the calculation of the ray marching. The reference map generation units 54 and 74 perform similar processing for each tile to calculate the gradient c, and then calculate the shrink factor by substituting the gradient c into Equation 2. The reference map of the shrink factor is generated by associating the calculated shrink factor with each tile, for example, which forms the hierarchical structure.

The reference map of the shrink factor is generated and updated in the same way as reference maps for other parameters, and is transmitted from the content server 20 to the image processing device 10 as needed. The display image generation unit 76 of the image processing device 10 references the shrink factor for each tile and multiplies the shrink factor by the distance D obtained from the height map, thereby performing the ray marching as described above and generating the display image. This allows for highly accurate display images to be generated in accordance with the uneven characteristics of the object surface without reducing the efficiency of the ray tracing.

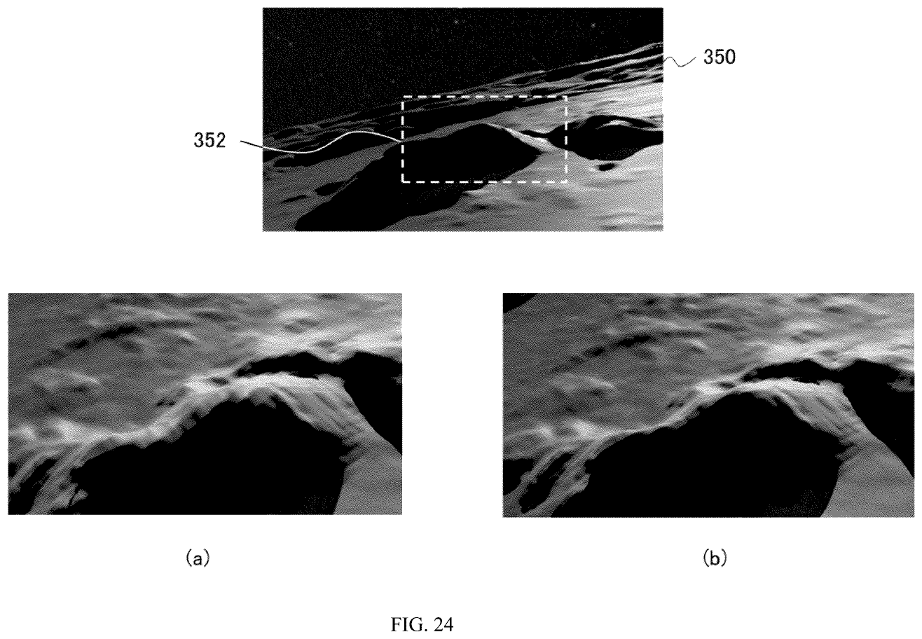

FIG. 24 illustrates the effect on the display image by introducing the shrink factor. In this example, the display target is the surface of the moon, as illustrated in an image 350 in the upper row. The image when the viewpoint is brought close to the mountain part of the area 352 is illustrated in the lower row, where (a) is the case when the shrink factor is not introduced and (b) is the case when the shrink factor is introduced.

As illustrated in the image, when the plain and mountain are close to each other and the mountain is viewed from the plain, there is a high possibility that rays will pass through the side surface of the mountain, as mentioned above. For this reason, when the shrink factor is not introduced, the shape of the mountain may change depending on the viewing direction, and unnatural shadows may appear along the mountain ridge, as illustrated in (a). By introducing the shrink factor, the original ridge can be rendered accurately, as illustrated in (b).

In the present embodiment described above, the reference map representing the distribution of parameters indicating the color values and other surface characteristics of the object to be displayed is generated at multiple resolutions, and when generating the display image, the pixel value is determined by selecting and referencing a level of detail that corresponds to the viewpoint or line of sight. When the change occurs in the image world, only the required area of the reference map for the corresponding parameters, at the required resolution, is locally updated. This makes it possible to reflect changes in the viewpoint or line of sight, as well as changes in the image world, in the display with low latency, even for large-scale models.

In addition, the reference maps can be generated and updated both on the image processing device used by each user and on the content server. This allows the content server, which has abundant resources, to generate and update the high-resolution reference maps and transmit the necessary data to the image processing device, while also enabling emergency responses within the image processing device to sudden changes in the viewpoint or image world, which can easily result in delays due to data transmission. The content server also transmits the layer and area data on a tile-by-tile basis, determined based on real-time viewpoint information. This allows display with the same amount of processing and transmission, regardless of the scale of the display target model or display magnification. All of this makes it possible to continue displaying high-quality images with low latency, regardless of the image content or environment.

The present invention has been described above based on an embodiment. The embodiment is merely an example, and those skilled in the art will understand that various modifications are possible in the combination of each component and each processing process, and that such modifications are also within the scope of the present invention.

### INDUSTRIAL APPLICABILITY

As described above, the present invention can be used in various information processing devices such as game devices, head-mounted displays, display devices, portable terminals, personal computers, content servers, and cloud servers, as well as image display systems that include any one of these.

### REFERENCE SIGNS LIST

1: Image display system, 10: Image processing device, 14: Input device, 16: Display device, 20: Content server, 22: CPU, 24: GPU, 26: Main memory, 50: Terminal information acquisition unit, 52: External data acquisition unit, 54: Reference map generation unit, 56: Transmission data identification unit, 58: Reference map storage unit, 60: Reference map transmission unit, 62: Input information acquisition unit, 64: Viewpoint information acquisition unit, 66: Terminal information transmission unit, 68: Reference map acquisition unit, 70: Reference map storage unit, 74: Reference map generation unit, 76: Display image generation unit.

1. An image processing device comprising one or more processors having hardware and at least one memory storing programming instructions, that, upon execution by the one or more processors cause the image processing device to perform operations comprising:
acquire hierarchical map data in which multiple reference maps representing distribution of color values of an object to be displayed and distribution of predetermined parameters indicating surface characteristics of the object are layered at different resolutions,
generate and output a display image using data of a layer and an area corresponding to viewpoint information for the object from among the hierarchical map data, and
upon a change occurring or a change being predicted in the object, selectively acquire and update data of a type, layer, and area of a reference map of the multiple reference maps that represents the change from among the hierarchical map data.

2. The image processing device according to claim 1, wherein the one or more processors generate and update data of a tile that represents the change from among tiles that are obtained by dividing the reference map of each layer constituting the hierarchical map data into tiles of a predetermined size.

3. The image processing device according to claim 1, wherein the one or more processors acquire and update data of a tile corresponding to the viewpoint information or data of a tile representing the change from a server, from among tiles obtained by dividing the reference map of each layer constituting the hierarchical map data into tiles of a predetermined size.

4. The image processing device according to claim 3, wherein the one or more processors acquire data of tiles of a layer and area corresponding to the viewpoint information from among the hierarchical map data by transmitting the viewpoint information to the server.

5. The image processing device according to claim 3, wherein the one or more processors acquire data of tiles of a layer and area by acquiring the layer and area corresponding to the viewpoint information from among the hierarchical map data and transmitting the viewpoint information on the layer and area to the server.

6. The image processing device according to claim 3, wherein the one or more processors switch, based on a predetermined switching condition, whether information to be transmitted to the server is to be the viewpoint information or to be the information on the layer and area corresponding to the viewpoint information from among the hierarchical map data.

7. The image processing device according to claim 1, wherein the one or more processors use the hierarchical map data representing, as a parameter distribution, a distribution of at least one of height, material, parameter used in procedural modeling, and feature vector representing an image world, to generate the display image.

8. The image processing device according to claim 1, wherein the one or more processors use the hierarchical map data including at least one of data representing a color value and a predetermined parameter distribution in full sphere or data representing the predetermined parameter distribution in central projection, to generate the display image.

9. The image processing device according to claim 1, wherein the one or more processors vary a layer of the hierarchical map data used to generate the display image depending on an area in a display image plane.

10. The image processing device according to claim 1, wherein the one or more processors vary a presence or an absence of distortion in the reference map used to generate the display image depending on an area in a display image plane.

11. The image processing device according to claim 1, wherein the one or more processors acquire the multiple reference maps used to generate the display image at different rates depending on an area in a display image plane.

12. The image processing device according to claim 1, wherein, among tiles obtained by dividing the reference map of each layer constituting the hierarchical map data into tiles of a predetermined size, depending on an approach of a viewpoint to a location on the object represented by a predetermined tile, the one or more processors switch a reference destination to another hierarchical map data or another reference map associated with the tile.

13. The image processing device according to claim 1, wherein the one or more processors
generate the display image by ray marching while referencing the hierarchical map data, and
calculate a distance between a ray and the object based on the reference map representing a height distribution as a parameter distribution, and determine a ray step size by adjusting the calculated distance based on a reference map representing a coefficient distribution by which the distance is multiplied as the parameter distribution.

14. The image processing device according to claim 13, wherein the one or more processors, for each tile obtained by dividing the reference map of each layer constituting the hierarchical map data into tiles of a predetermined size, acquire a coefficient based on a maximum gradient of an object surface, and determine a final coefficient by adjusting a range for obtaining the maximum gradient by determining whether the range is inside or outside an inverted cone having an inclination of a corresponding side surface and the object surface.

15. The image processing device according to claim 1, wherein the one or more processors
generate the hierarchical map data necessary for generating the display image in response to the change in the viewpoint information or object, and generate the display image using the generated hierarchical map data, and
update the display image using the hierarchical map data transmitted from a server in response to the change in the viewpoint information or the object.

16. A content server comprising one or more processors having hardware,
wherein the one or more processors
generate hierarchical map data in which multiple reference maps representing distribution of color values of an object to be displayed and distribution of predetermined parameters indicating surface characteristics of the object are layered at different resolutions, and
transmit data of a layer and area of the hierarchical map data determined based on viewpoint information for the object to an image processing device that generates and displays a display image using the hierarchical map data.

17. The content server according to claim 16, wherein the one or more processors generate a reference map of the multiple reference maps having distortion in a direction that cancels out distortion caused by an eyepiece lens based on the viewpoint information.

18. The content server according to claim 16, wherein the one or more processors vary at least one of a layer to be transmitted, a rate, and presence or absence of distortion in the hierarchical map data according to an area of the reference map, based on the viewpoint information.

19. The content server according to claim 16, wherein the one or more processors selectively update a type, layer, and area data of the reference map in the hierarchical map data based on at least one of a user operation content, captured image, and sensor output data transmitted from the image processing device.

20. An image processing method comprising:
acquiring hierarchical map data in which multiple reference maps representing distribution of color values of an object to be displayed and distribution of predetermined parameters indicating surface characteristics of the object are layered at different resolutions;
generating and outputting a display image using data of a layer and an area corresponding to viewpoint information for the object from among the hierarchical map data; and
when a change occurs or a change is predicted in the object, selectively acquiring and updating data of a type, layer, and area of the reference map that represents the change from among the hierarchical map data.
